(19) United States
(12) Patent Application Publication
(10) Pub. No.: US 2024/0070236 A1
(43) Pub. Date: Feb. 29, 2024

(54) ASSET-CLASS BACKED TOKENIZATION PLATFORM

(71) Applicant: Strong Force TX Portfolio 2018, LLC, Fort Lauderdale, FL (US)

(72) Inventor: Charles Howard Cella, Pembroke, MA (US)

(21) Appl. No.: 18/371,615

(22) Filed: Sep. 22, 2023

Related U.S. Application Data
(63) Continuation of application No. PCT/US22/21783, filed on Mar. 24, 2022.
(60) Provisional application No. 63/165,433, filed on Mar. 24, 2021.
(60) Provisional application No. 63/221,899, filed on Jul. 14, 2021.

(51) Int. Cl. G06F 21/10; H04L 9/00

(52) U.S. Cl. CPC G06F 21/1074; G06F 21/108; H04L 9/50

(57) ABSTRACT

Systems, methods and apparatus relating to asset-class based tokens are described. An example apparatus may include a tokenization controller to implement a tokenization user interface where the tokenization controller includes a token definition circuit to interpret a token description in response to user operations. The example apparatus may further include an asset definition circuit to interpret an asset-class description in response to user operations and an asset backing circuit to interpret a token link description including a token performance representation corresponding to a beneficial characteristic of at least one asset of the asset-class description, and to generate at least one asset-class linked token in response to the token link description and the asset-class description. The example apparatus may further include a token deployment circuit to expose the at least one asset-class linked token to a token marketplace system.

### CROSS-REFERENCE TO RELATED APPLICATIONS

This application claims priority to and is a continuation of International Patent Application Serial No.: PCT/US2022/021783 (SFTX-0021-WO) filed Mar. 24, 2022, and entitled “ASSET-BACKED TOKENIZATION PLATFORM,” and published on Sep. 29, 2022, as WO 2022/204425 A1.

International Patent Application Serial No.: PCT/US2022/021783 (SFTX-0021-WO) claims priority to the following U.S. Provisional Applications: Ser. No. 63/165,433 (SFTX-0021-PO1) filed Mar. 24, 2021, and entitled “ASSET-BACKED TOKENIZATION PLATFORM”; and Ser. No. 63/221,899 (SFTX-0021-P02) filed Jul. 14, 2021, and entitled “ASSET-BACKED TOKENIZATION PLATFORM.”

Each of the foregoing applications is incorporated herein by reference in its entirety.

U.S. patent application Ser. No. 17/554,663 (SFTX-0020-U01), filed Dec. 17, 2021, entitled “MARKET ORCHESTRATION SYSTEM FOR FACILITATING ELECTRONIC MARKETPLACE TRANSACTIONS”, and published on Nov. 17, 2022, as US 2022/0366494 A1, is also incorporated by reference in its entirety.

### BACKGROUND

Cryptocurrencies appear to be here to stay, as leading players like Bitcoin and Ethereum, as well as emerging ones like Crypto Kitties, have generated astounding levels of wealth and mainly private valuations. Many concerns remain, including volatility, lack of “true utility” that allows fundamental value analysis, and anticipated regulatory crackdown, among others. As a result, most institutional investment platforms either do not support trading in cryptocurrencies for their clients or offer very constrained access. However, investor interest continues to grow despite these limitations.

While bespoke tokens exist that are linked to other asset classes, such as patents or works of art, the range of possible types is almost certain to proliferate, leading to challenges for designers, purchasers, sellers, lenders, and others who interact with tokens, such as in marketplaces and exchanges.

### SUMMARY

Embodiments herein provide for tokens that solve or mitigate the problems with current cryptocurrencies, and a platform that facilitates convenient design, development, and deployment of such tokens. One key issue, utility, can be addressed by backing a cryptocurrency with another asset or asset class, in particular one that is more amenable to fundamental valuation analysis. Embodiments herein provide a robust platform that facilitates design, development, simulation, deployment, monitoring and analysis of new sets of tokens, including ones linked to a wide range of alternative asset classes, to a mix of asset classes, and to aspects of an asset class, such as a risk profile, volatility profile, and/or value profile, including value responses to certain types of events.

An asset-backed tokenization platform is disclosed which includes a set of interconnected tools, services and applications to enable users to design, develop, simulate, deploy, monitor and analyze cryptographically secure, tradeable tokens, such as ones that are linked to or backed by one or more other asset classes, including alternative asset classes such as revenue streams from intellectual property, farms, manufacturing production capacity, energy production facilities, and real estate. In the platform users may discover characteristics of asset classes and related tokens, configure token sets to satisfy a set of goals and/or to adhere to a strategy (e.g., by designing a set of tokens and/or an umbrella token that provides a risk/reward profile that is tuned to the goals of the designer). These tokens may render the drivers of volatility more transparent by tying them to the other asset classes, may mitigate or manage volatility by blending or combining the economic characteristics of multiple asset classes, may be configured to satisfy diversification and/or asset allocation goals, and the like.

Tokens linked to alternative asset classes may be referred to herein as “asset-backed tokens,” “asset-class-backed tokens,” “asset-linked tokens,” and the like. Such terms are used interchangeably except where context indicates otherwise. Backing or linking of a token with an alternative asset class or member thereof may be undertaken in a variety of ways, such as, without limitation: indexing the value of a token to a set of economic parameters of an asset class or particular asset or value stream within it (e.g., the amount of income generated by an asset, the valuation ascribed to the token in a secondary market, lending market, or insurance market, the value of an index on the underlying asset class or member, or many others); making a token redeemable for a set of units and/or a particular portion of a value stream (e.g., a percentage share, a time period, or combination thereof); using the token as an access-control mechanism for a holder to access a value stream (e.g., the right to control production of units by a 3D printer); setting a rule, algorithm, or the like by which the value of the token is determined, where the rule operates on underlying economic data associated with an asset class or member thereof (e.g., basing a real estate token's value on the average selling price of real estate in a relevant geography); comparing the token to other tokens that have similar characteristics (e.g., other tokens that are redeemable for a similar asset class or member thereof); and others. References to linking or backing throughout this disclosure are intended to encompass any of these, or combinations of these, except where context specifically indicates otherwise.

### BRIEF DESCRIPTION OF FIGURES

FIG. 1 schematically depicts components and interactions of an asset-backed tokenization platform, applications, and supporting systems in accordance with various embodiments.

FIG. 2 schematically depicts an asset-based tokenization platform in accordance with various embodiments.

FIG. 3 schematically depicts a token design system in accordance with various embodiments.

FIG. 4 depicts token attributes in accordance with various embodiments.

FIG. 5 depicts asset class attributes in accordance with various embodiments.

FIG. 6 depicts asset token framework parameters in accordance with various embodiments.

FIG. 7 depicts parameters for a token simulator in accordance with various embodiments.

FIG. 8 depicts an example system for creating asset linked tokens.

FIG. 9 depicts an example tokenization controller.

FIG. 10 depicts an example token link description.

FIG. 11 depicts an example token deployment controller.

FIG. 12 depicts an example token marketplace controller.

FIG. 13 depicts an example asset class description.

FIG. 14 depicts an example beneficial characteristic.

FIG. 15 depicts an example performance representation.

FIG. 16 depicts an example procedure to generate an asset class linked token.

FIG. 17 depicts an example procedure to generate an asset linked token.

FIG. 18 depicts an example procedure to adjust an asset linked token.

FIG. 19 depicts an example strategy engine.

### DETAILED DESCRIPTION

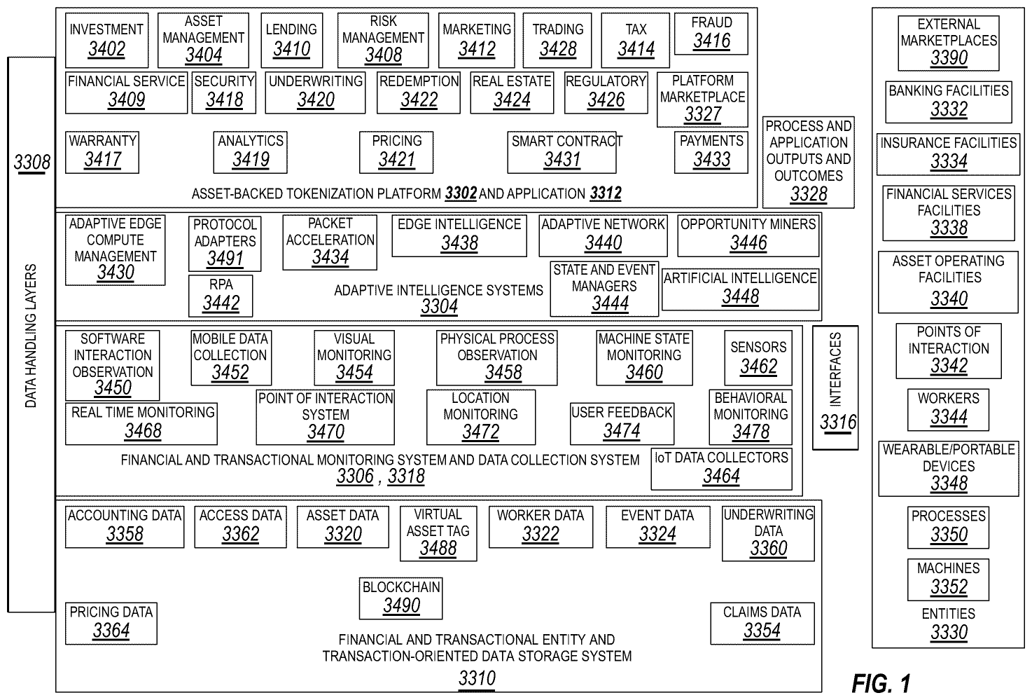

Referring to FIG. 1, additional details, components, sub-systems, and other elements of an optional embodiment of an asset-backed tokenization platform layer 3302 and associated applications 3312 are illustrated. The asset-backed tokenization platform layer 3302 and subsequent figures. The data handling layers can automatically collect relevant information, such as through edge, IoT, and other networking systems, can store the relevant data for use by relevant services and applications (including ones involved in token design, configuration, simulation, deployment, monitoring and analysis), can apply various algorithms and intelligence to the data (including for producing relevant analytics, for simulation of token behavior, for similarity and clustering and other uses), and the like. All of these capabilities enable the various core capabilities of an asset-backed tokenization platform described throughout this disclosure. The asset-backed tokenization platform layer 3302 may, in various optional embodiments, include a set of applications, systems, solutions, interfaces, or the like, collectively referred to for convenience as applications 3312, by which an operator or owner of an asset, token, transactional or financial entity, or other users, may manage, monitor, control, analyze, or otherwise interact with one or more elements of the financial and transactional entity 3330. In embodiments, the asset-backed tokenization platform layer 3302 may include a set of data handling layers 3308 each of which is configured to provide a set of capabilities that facilitate development and deployment of intelligence, such as for facilitating automation, machine learning, applications of artificial intelligence, intelligent transactions, state management, event management, process management, and many others, for a wide variety of financial and transactional applications and end uses. In embodiments, the data handling layers 3308 include a financial and transactional monitoring systems layer 3306, a financial and transactional entity-oriented data storage systems layer 3310 (referred to in some cases herein for convenience simply as a data storage layer 3310), an adaptive intelligence systems layer 3304 and an asset-backed tokenization platform layer 3302. Each of the data handling layers 3308 may include a variety of services, programs, applications, workflows, systems, components, and modules, as further described herein and in the documents incorporated herein by reference. In embodiments, each of the data handling layers 3308 (and optionally the asset-backed tokenization platform layer 3302 as a whole) is configured such that one or more of its elements can be accessed as a service by other data handling layers 3308 or by other systems (e.g., being configured as a platform-as-a-service deployed on a set of cloud infrastructure components in a microservices architecture). For example, a data handling layer 3308 may have a set of application programming interfaces 3316, such as application programming interfaces (APIs), brokers, services, connectors, wired or wireless communication links, ports, human-accessible interfaces, software interfaces or the like by which data may be exchanged between the data handling layer 3308 and other layers, systems or sub-systems of the asset-backed tokenization platform layer 3302, as well as with other systems, such as financial and transactional entities 3330 or external systems, such as cloud-based or on-premises enterprise systems (e.g., accounting systems, resource management systems, CRM systems, supply chain management systems and many others. Each of the data handling layers 3308 may include a set of services (e.g., microservices), for data handling, including facilities for data extraction, transformation and loading; data cleansing and deduplication facilities; data normalization facilities; data synchronization facilities; data security facilities; computational facilities (e.g., for performing pre-defined calculation operations on data streams and providing an output stream); compression and de-compression facilities; analytic facilities (such as providing automated production of data visualizations) and others.

In embodiments, each data handling layer 3308 has a set of application programming interfaces 3316 for automating data exchange with each of the other data handling layers 3308. These may include data integration capabilities, such as for extracting, transforming, loading, normalizing, compression, decompressing, encoding, decoding, and otherwise processing data packets, signals, and other information as it exchanged among the layers and/or the applications 3312, such as transforming data from one format or protocol to another as needed in order for one layer to consume output from another. In embodiments, the data handling layers 3308 are configured in a topology that facilitates shared data collection and distribution across multiple applications and uses within the asset-backed tokenization platform layer 3302 by the financial and transactional monitoring systems layer 3306. The financial and transactional monitoring systems layer 3306 may include, integrate with, and/or cooperate with various data collection and management systems 3318, referred to for convenience in some cases as data collection systems 3318, for collecting and organizing data collected from or about financial and transactional entities 3330, as well as data collected from or about the various data handling layers 3308 or services or components thereof.

The set of applications 3312 may include, without limitation, one or more of any of a wide range of types of applications, such as an investment application 3402 (such as, without limitation, for investment in shares, interests, currencies, commodities, options, futures, derivatives, real property, trusts, cryptocurrencies, tokens, and other asset classes); an asset management application 3404 (such as, without limitation, for managing investment assets, real property, fixtures, personal property, real estate, equipment, intellectual property, vehicles, human resources, software, information technology resources, data processing resources, data storage resources, power generation and/or storage resources, computational resources and other assets); a lending application 3410 (such as, without limitation, for personal lending, commercial lending, collateralized lending, microlending, peer-to-peer lending, insurance-related lending, asset-backed lending, secured debt lending, corporate debt lending, student loans, mortgage lending, automotive lending, and others); a risk management application 3408 (such as, without limitation, for managing risk or liability with respect to a product, an asset, a person, a home, a vehicle, an item of equipment, a component, an information technology system, a security system, a security event, a cybersecurity system, an item of property, a health condition, mortality, fire, flood, weather, disability, malpractice, business interruption, infringement, advertising injury, slander, libel, violation of privacy or publicity rights, injury, damage to property, damage to a business, breach of a contract, and others); a payments application 3433 (such as for enabling various payments within and across marketplaces, including credit card, debit card, wire transfer, ACH, checking, currency and other payments); a marketing application 3412 (such as, without limitation, an application for marketing a financial or transactional product or service, an advertising application, a marketplace platform or system for goods, services or other items, a marketing analytics application, a customer relationship management application, a search engine optimization application, a sales management application, an advertising network application, a behavioral tracking application, a marketing analytics application, a location-based product or service targeting application, a collaborative filtering application, a recommendation engine for a product or service, and others); a trading application 3428 (such as, without limitation, a buying application, a selling application, a bidding application, an auction application, a reverse auction application, a bid/ask matching application, a securities trading application, a commodities trading application, an option trading application, a futures trading application, a derivatives trading application, a cryptocurrency trading application, a token-trading application, an analytic application for analyzing financial or transactional performance, yield, return on investment, or other metrics, a book-building application, or others); a tax application 3414 (such as, without limitation, for managing, calculating, reporting, optimizing, or otherwise handling data, events, workflows, or other factors relating to a tax, a levy, a tariff, a duty, a credit, a fee or other government-imposed charge, such as, without limitation, sales tax, income tax, property tax, municipal fees, pollution tax, renewal energy credit, pollution abatement credit, value added tax, import duties, export duties, and others); a fraud prevention application 3416 (such as, without limitation, one or more of an identity verification application, a biometric identify validation application, a transactional pattern-based fraud detection application, a location-based fraud detection application, a user behavior-based fraud detection application, a network address-based fraud detection application, a black list application, a white list application, a content inspection-based fraud detection application, or other fraud detection application, a financial service, application or solution 3409 (referred to collectively as a “financial service”, such as, without limitation, a financial planning service, a tax planning service, a portfolio management service, a transaction service, a lending service, a banking service, a currency conversion service, a currency exchange service, a remittance service, a money transfer service, a wealth management service, an estate planning service, an investment banking service, a commercial banking service, a foreign exchange service, an insurance service, an investment service, an investment management service, a hedge fund service, a mutual fund service, a custody service, a credit card service, a safekeeping service, a checking service, a debit card service, a lending service, an ATM service, an ETF service, a wire transfer service, an overdraft service, a reporting service, a certified checking service, a notary service, a capital markets service, a brokerage service, a broker-dealer service, a private banking service, an insurance service, an insurance brokerage service, an underwriting service, an annuity service, a life insurance service, a health insurance service, a retirement insurance service, a property insurance service, a casualty insurance service, a finance and insurance service, a reinsurance service, an intermediation service, a trade clearinghouse service, a private equity service, a venture capital service, an angel investment service, a family office investment service, an exchange service, a payments service, a settlement service, an interbank networking service, a debt resolution service, or other financial service); a security application, solution or service 3418 (referred to herein as a security application, such as, without limitation, any of the fraud prevention applications 3416 noted above, as well as a physical security system (such as for an access control system (such as using biometric access controls, fingerprinting, retinal scanning, passwords, and other access controls), a safe, a vault, a cage, a safe room, or the like), a monitoring system (such as using cameras, motion sensors, infrared sensors and other sensors), a cyber security system (such as for virus detection and remediation, intrusion detection and remediation, spam detection and remediation, phishing detection and remediation, social engineering detection and remediation, cyber-attack detection and remediation, packet inspection, traffic inspection, DNS attack remediation and detection, and others) or other security application); an underwriting application 3420 (such as, without limitation, for underwriting any insurance offering, any loan, or any other transaction, including any application for detecting, characterizing or predicting the likelihood and/or scope of a risk, including underwriting based on any of the data sources, events or entities noted throughout this disclosure or the documents incorporated herein by reference); a redemption application 3422 (such as, without limitation, a distribution system for providing an investor or owner with the output of the underlying asset class, or member thereof that is linked to or that backs the token, whether the output is a financial dividend, a revenue share, a production facility, or the like, which can involve any of the linking or backing frameworks noted herein (e.g., using a token as evidence of a redemption right, using a token as an access control mechanism for a production element, tying the value of a token to an index, etc.) and which can be optionally deployed through existing financial intermediaries or through one or more peer-to-peer payment systems); a real estate application 3424 (such as, without limitation, a real estate brokerage application, a real estate valuation application, a real estate investment trust application, a real estate mortgage or lending application, a real estate assessment application, a real estate marketing application, or other); a regulatory application 3426 (such as, without limitation, an application for regulating any of the applications, services, transactions, activities, workflows, events, entities, or other items noted herein and in the documents incorporated by reference herein, such as regulation of pricing, marketing, offering of securities, offering of insurance, undertaking of broker or dealer activities, use of data (including data privacy regulations, regulations relating to storage of data and others), banking, marketing, sales, financial planning, and many others); a platform-operated marketplace 3327 application, solution or service (referred to in some cases simply as a marketplace application (which term may also, as context permits include various types of external marketplaces 3390), such as, without limitation an e-commerce marketplace, an auction marketplace, a physical goods marketplace, a virtual goods marketplace, an advertising marketplace, a reverse-auction marketplace, an advertising network, a marketplace for attention resources, an energy trading marketplace, a marketplace for computing resources, a marketplace for networking resources, a spectrum allocation marketplace, an Internet advertising marketplace, a television advertising marketplace, a print advertising marketplace, a radio advertising marketplace, an in-game advertising marketplace, an in-virtual reality advertising marketplace, an in-augmented reality marketplace, a real estate marketplace, a hospitality marketplace, a travel services marketplace, a financial services marketplace, a blockchain-based marketplace, a cryptocurrency marketplace, a token-based marketplace, a loyalty program marketplace, a time share marketplace, a rideshare marketplace, a mobility marketplace, a transportation marketplace, a space-sharing marketplace, or other marketplace); a warranty application 3417 (such as, without limitation, an application for a warranty or guarantee with respect to a product, a service, an offering, a solution, a physical product, software, a level of service, quality of service, a financial instrument, a debt, an item of collateral, performance of a service, or other item); an analytics solution 3419 (such as, without limitation, an analytic application with respect to any of the data types, applications, events, workflows, or entities mentioned throughout this disclosure or the documents incorporated by reference herein, such as a big data application, a user behavior application, a prediction application, a classification application, a dashboard, a pattern recognition application, an econometric application, a financial yield application, a return on investment application, a scenario planning application, a decision support application, and many others); a pricing application 3421 (such as, without limitation, for pricing of goods, services (including any mentioned throughout this disclosure and the documents incorporated by reference herein), applications (including any mentioned throughout this disclosure and the documents incorporated by reference herein), software, data services, insurance, virtual goods, advertising placements, search engine and keyword placements, and many others; and a smart contract application, solution, or service (referred to collectively herein as a smart contract application, such as, without limitation, any of the smart contract types referred to in this disclosure or in the documents incorporated herein by reference, such as a smart contract using a token or cryptocurrency for consideration, a smart contract that vests a right, an option, a future, or an interest based on a future condition, a smart contract for a security, commodity, future, option, derivative, or the like, a smart contract for current or future resources, a smart contract that is configured to account for or accommodate a tax, regulatory or compliance parameter, a smart contract that is configured to execute an arbitrage transaction, or many others). Thus, the asset-backed tokenization platform layer 3302 may host an enable interaction among a wide range of disparate applications 3312 (such term including the above-referenced and other financial or transactional applications, services, solutions, and the like), such that by virtue of shared microservices, shared data infrastructure, and shared intelligence, any pair or larger combination or permutation of such services may be improved relative to an isolated application of the same type.

In embodiments, the adaptive intelligence systems layer 3304 may include a set of systems, components, services, and other capabilities that collectively facilitate the coordinated development and deployment of intelligent systems, such as ones that can enhance one or more of the applications 3312 at the asset-backed tokenization platform layer 3302. These adaptive intelligence systems layer 3304 may include an adaptive edge compute management solution 3430, a robotic process automation system 3442, a set of protocol adaptors 3491, a packet acceleration system 3434, an edge intelligence system 3438, an adaptive networking system 3440, a set of state and event managers 3444, a set of opportunity miners 3446, a set of artificial intelligence systems 3448 and other systems. The robotic process automation system 3442 may be configured to take outputs and outcomes 3328 from various applications.

In embodiments, the financial and transactional monitoring systems layer 3306 and its data collection systems 3318 may include a wide range of systems for collection of data. This layer may include, without limitation, real time monitoring systems 3468 (such as onboard monitoring systems like event and status reporting systems on ATMs, POS systems, kiosks, vending machines and the like; onboard diagnostic and telematics systems on vehicle and equipment; systems providing diagnostic codes and events via an event bus, communication port, or other communication system; monitoring infrastructure (such as cameras, motion sensors, beacons, RFID systems, smart lighting systems, asset tracking systems, person tracking systems, and ambient sensing systems located in various environments where transactions and other events take place), as well as removable and replaceable monitoring systems, such as portable and mobile data collectors, RFID and other tag readers, smart phones, tablets and other mobile device that are capable of data collection and the like); software interaction observation systems 3450 (such as for logging and tracking events involved in interactions of users with software user interfaces, such as mouse movements, touchpad interactions, mouse clicks, cursor movements, keyboard interactions, navigation actions, eye movements, finger movements, gestures, menu selections, and many others, as well as software interactions that occur as a result of other programs, such as over APIs, among many others); mobile data collectors 3452 (such as described extensively herein and in documents incorporated by reference), visual monitoring systems 3454 (such as using video and still imaging systems, LIDAR, IR and other systems that allow visualization of items, people, materials, components, machines, equipment, personnel, gestures, expressions, positions, locations, configurations, and other factors or parameters of financial and transactional entities 3330, as well as inspection systems that monitor processes, activities of workers and the like); point of interaction systems 3470 (such as point of sale systems, kiosks, ATMs, vending machines, touch pads, camera-based interaction tracking systems, smart shopping carts, user interfaces of online and in-store vending and commerce systems, tablets, and other systems at the point of sale or other interaction by a customer or worker involved in shopping and/or a transaction); physical process interaction observation systems 3458 (such as for tracking physical activities of customers, physical activities of transaction parties (such as traders, vendors, merchants, customers, negotiators, brokers, and the like), physical interactions of workers with other workers, interactions of workers with physical entities like machines and equipment, and interactions of physical entities with other physical entities, including, without limitation, by use of video and still image cameras, motion sensing systems (such as including optical sensors, LIDAR, IR and other sensor sets), robotic motion tracking systems (such as tracking movements of systems attached to a human or a physical entity) and many others; machine state monitoring systems 3460 (including onboard monitors and external monitors of conditions, states, operating parameters, or other measures of the condition of a machine, such as a client, a server, a cloud resource, an ATM, a kiosk, a vending machine, a POS system, a sensor, a camera, a smart shopping cart, a smart shelf, a vehicle, a robot, or other machine); sensors and cameras 3462 and other IoT data collection systems 3464 (including onboard sensors, sensors or other data collectors (including click tracking sensors) in or about a financial or transactional environment (such as, without limitation, an office, a back office, a store, a mall, a virtual store, an online environment, a web site, a bank, or many others), cameras for monitoring an entire environment, dedicated cameras for a particular machine, process, worker, or the like, wearable cameras, portable cameras, cameras disposed on mobile robots, cameras of portable devices like smart phones and tablets, and many others, including any of the many sensor types disclosed throughout this disclosure or in the documents incorporated herein by reference); indoor location monitoring systems 3472 (including cameras, IR systems, motion-detection systems, beacons, RFID readers, smart lighting systems, triangulation systems, RF and other spectrum detection systems, time-of-flight systems, chemical noses and other chemical sensor sets, as well as other sensors); user feedback systems 3474 (including survey systems, touch pads, voice-based feedback systems, rating system, expression monitoring systems, affect monitoring systems, gesture monitoring systems, and others); behavioral monitoring systems 3478 (such as for monitoring movements, shopping behavior, buying behavior, clicking behavior, behavior indicating fraud or deception, user interface interactions, product return behavior, behavior indicative of interest, attention, boredom or the like, mood-indicating behavior (such as fidgeting, staying still, moving closer, or changing posture) and many others); and any of a wide variety of Internet of Things (IoT) data collection systems 3464, such as those described throughout this disclosure and in the documents incorporated by reference herein.

Financial and transactional entities 3330 may include any of the wide variety of assets, systems, devices, machines, facilities, individuals or other entities mentioned throughout this disclosure or in the documents incorporated herein by reference, such as, without limitation: financial machines 3352 and their components (e.g., automated teller machines, point of sale machines, vending machines, kiosks, smart-card-enabled machines, and many others); financial and transactional processes 3350 (such as lending processes, software processes (including applications, programs, services, and others), production processes, banking processes (e.g., lending processes, underwriting processes, investing processes, and many others), financial service processes, diagnostic processes, security processes, safety processes and many others); wearable and portable devices 3348 (such as mobile phones, tablets, dedicated portable devices for financial applications, data collectors (including mobile data collectors), sensor-based devices, watches, glasses, hearables, head-worn devices, clothing-integrated devices, arm bands, bracelets, neck-worn devices, AR/VR devices, headphones, and many others); workers 3344 (such as banking workers, financial service personnel, managers, engineers, floor managers, vault workers, inspectors, delivery personnel, currency handling workers, process supervisors, security personnel, safety personnel and many others); points of interaction 3342 (e.g., kiosks, ATMs, point-of-sale systems, cash registers, checkout systems, points of use and many others); and asset operating facilities 3340 (such as currency production facilities, storage facilities, vaults, bank branches, office buildings, banking facilities, financial services facilities, cryptocurrency mining facilities, data centers, trading floors, high frequency trading operations, and many others), which may include, without limitation, among many others, storage and financial services facilities 3338 (such as for financial services inventory, components, packaging materials, goods, products, machinery, equipment, and other items); insurance facilities 3334 (such as branches, offices, storage facilities, data centers, underwriting operations and others); and banking facilities 3332 (such as for commercial banking, investing, consumer banking, lending and many other banking activities).

In embodiments, the data storage layer 3310 may include a range of systems for storage of data, such as the accounting data 3358, access data 3362, pricing data 3364, asset data 3320, worker data 3322, event data 3324, underwriting data 3360 and claims data 3354. Asset data 3320 may include a wide range of historical and/or forecasted economic and other data and attributes associated with an asset class or member thereof, including price data, revenue data, profit data, yield data, rental income data, production volume data, timing data, operational data (e.g., historical and forecast production output), status data (e.g., state of health, maintenance or operating condition), workflow data (such as past and forecast activities of an asset), aggregate or index data, valuation data, ratings data (including credit ratings, quality ratings, and the like), and many others. Data storage layer 3310 may include, without limitation, physical storage systems, virtual storage systems, local storage systems, distributed storage systems, databases, memory, network-based storage, network-attached storage systems (such as using NVME, storage attached networks, and other network storage systems), and many others. In embodiments, the data storage layer 3310 may store data in one or more knowledge graphs (such as a directed acyclic graph, a data map, a data hierarchy, a data cluster including links and nodes, a self-organizing map, or the like). In embodiments, the data storage layer 3310 may store data in a digital thread, ledger, or the like, such as for maintaining a longitudinal record of a financial and transactional entity 3330 over time, including any of the entities described herein. In embodiments, the data storage layer 3310 may use and enable a virtual asset tag 3488, which may include a data structure that is associated with an asset and accessible and managed as if the tag were physically located on the asset, such as by use of access controls, so that storage and retrieval of data are optionally linked to local processes, but also optionally open to remote retrieval and storage options. In embodiments, the data storage layer 3310 may include one or more blockchains 3490, such as ones that store identity data, transaction data, entity data for the financial and transactional entities 3330, pricing data, ownership transfer data, data for operation by smart contracts 3431, historical interaction data, and the like, such as with access control that may be role-based or may be based on credentials associated with a financial and transactional entity 3330, a service, or one or more applications 3312.

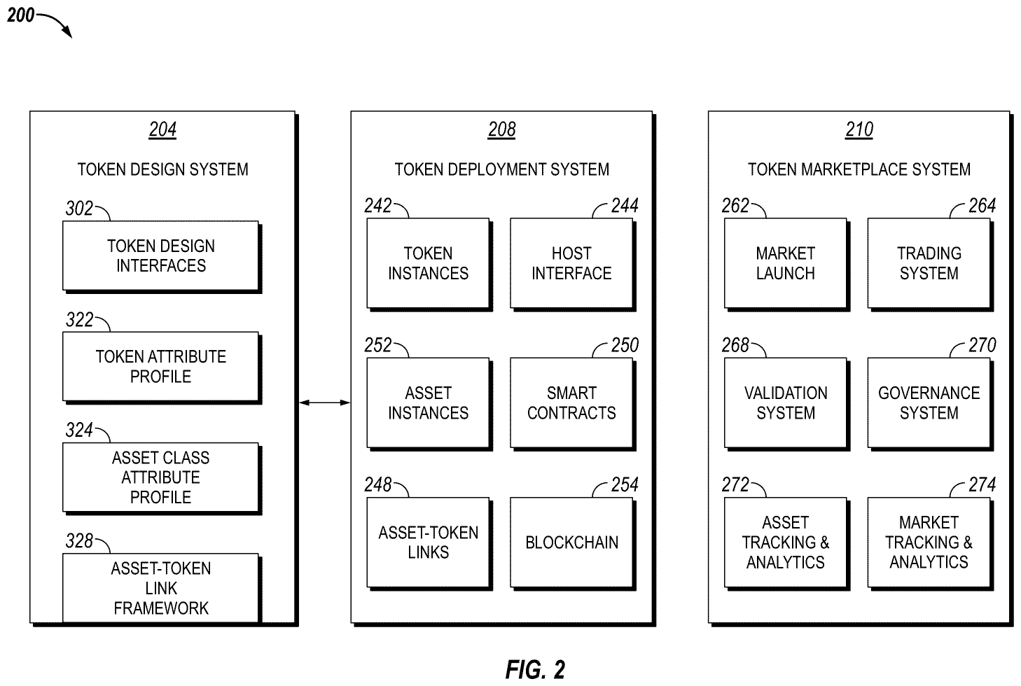

Referring to FIG. 2, an asset-backed tokenization platform 200 is shown. The asset-backed tokenization platform 200 may include a set of interconnected tools, services and applications to enable users to design, develop, simulate, deploy, monitor and analyze cryptographically secure, tradeable tokens, such as ones that are linked to or backed by one or more other asset classes, including alternative asset classes such as revenue streams from intellectual property, farms, manufacturing production capacity, energy production facilities, and real estate, among many others. Any asset class that produces a revenue or value stream, whether denominated in currency or other units (e.g., energy, attention (e.g., page views, clicks, or the like) may be linked or associated with a token or set of tokens to provide backing, utility or linking that supports the token. This may include linking or backing to revenue streams (e.g., from rental, royalties, revenue sharing agreement, sales commissions, services, and many others); valuations (e.g., to indexes of securities, bonds, currencies, points, tokens, and the like); production units (e.g., of goods, energy, materials, commodities, and the like); services (e.g., data services, physical services, microservices, networking services and the like); behaviors (e.g., attention); and others.

In the asset-backed tokenization platform 200 users may discover characteristics of the asset classes that may be linked to or back tokens as well as characteristics of the tokens (and similar other ones). This may include data collection from public data sources, proprietary data sources, historical data, and the like, using the various mechanisms noted in connection with FIG. 1 and the embodiment of the asset-backed tokenization platform layer 3302 associated therewith.

Using the interfaces of the asset-backed tokenization platform 200, token designers may configure token sets to satisfy a set of goals and/or to adhere to a strategy (e.g., by designing a set of tokens and/or an umbrella token that provides a risk/reward profile that is tuned to the goals of the designer). The designed tokens may render the drivers of volatility more transparent, such as by tying them to the other asset classes, may mitigate or manage volatility (such as by blending or combining the economic characteristics of multiple asset classes), may be configured to satisfy diversification and/or asset allocation goals (such as by linking to multiple asset classes such that a set of tokens behaves economically like a portfolio or fund), and the like.

The asset-backed tokenization platform 200 may include a token design system 204, a token deployment system 208, and a token marketplace system 210. A token design system may include token design interfaces 302 to enable a user to design a token having a specified token attribute profile 322, a specified asset class attribute profile 324, and an asset-token link framework 328. Configuring a token in the token design system 204 interface may include selecting and/or configuring the nature of the backing or linking of a token with an alternative asset class or member thereof. Such backing or linking may be undertaken in a variety of ways, such as, without limitation: indexing the value of a token to a set of economic parameters of an asset class or particular asset or value stream within it (e.g., the amount of income generated by an asset, the valuation ascribed to the token in a secondary market, lending market, or insurance market, the value of an index on the underlying asset class or member, or many others); making a token redeemable for a set of units and/or a particular portion of a value stream (e.g., a percentage share, a time period, or combination thereof); using the token as an access-control mechanism for a holder to access a value stream (e.g., the right to control production of units by a 3D printer); setting a rule, algorithm, or the like by which the value of the token is determined, where the rule operates on underlying economic data associated with an asset class or member thereof (e.g., basing a real estate token's value on the average selling price of real estate in a relevant geography); comparing the token to other tokens that have similar characteristics (e.g., other tokens that are redeemable for a similar asset class or member thereof); and others. As noted above, references to linking or backing throughout this disclosure are intended to encompass any of these, or combinations of these, except where context specifically indicates otherwise. Selecting and configuring may include choosing an asset class (such as from a drop-down menu), choosing a linking framework among various available ones, determining a number of tokens, setting timing for release, and configuring other attributes (e.g., redemption rules, timing of releases, trading rules, and the like). As such, the token design system may interpret a token link description comprising a token performance representation that corresponds to a beneficial characteristic of at least one asset and/or its asset class and the corresponding asset class description to the at least one asset and/or its asset class. The token design system may also generate at least one asset class linked token in response to the token link description and the asset class description. The token deployment system 208 may include token instances 242, asset instances 252, asset-token links 248, a host interface 244, smart contracts 250, and blockchains 254.

Once designed, a token may be simulated before being deployed, such as in a token simulation system that simulates the behavior of the token based on historical economic data regarding the backing or linked asset class, as well as forecast data. Simulations may include algorithmic simulations, such as ones that aggregate other simulations, including ones that cover underlying asset classes. Simulations may allow the designer to anticipate and adjust for likely events, as well as to set up rules that address unlikely (e.g., “black swan”) events. Simulations may use data collection from real marketplaces, as well as simulated marketplaces, and may take advantage of various artificial intelligence and machine learning capabilities noted throughout this disclosure and the documents incorporated by reference herein.

When ready, the token may be deployed in a token marketplace, such as using the token marketplace system 210, which may include systems for market launch 262, market tracking and analytics 274 and an asset tracking and analytics 272. The token marketplace system 210 may further include a trading system 264, a governance system 270, and a validation system 268 or further examples of such systems as they relate to one or more asset classes.

Token designers can interact with token design interfaces 302 of the asset-backed tokenization platform 200 to design the attributes of a proposed asset-based token 318 based on the asset classes they represent. A token designer may select blockchains and consensus algorithms for validation, set tokenomics parameters where applicable, determine quantities and timing for launching tranches of tokens, set opening prices, create governing rules for trading, and the like. Token design can allow tuning of token attributes to the attributes of the underlying asset class, including aligned timing, risk/reward curve, etc.

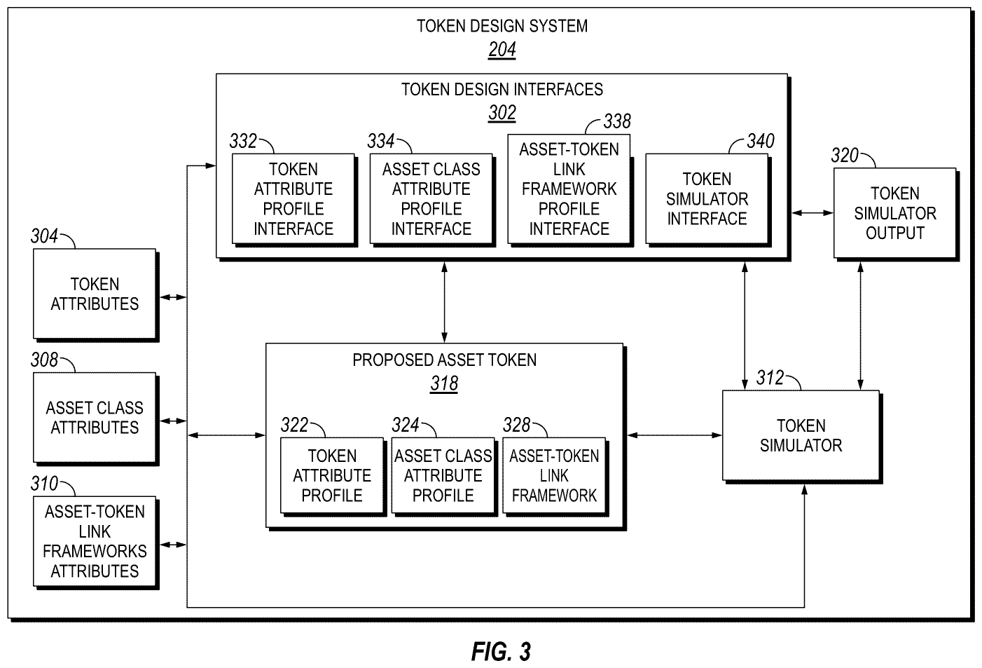

Referring to FIG. 3, the token design system 204, may include a token design interface 302 (also referenced as a user interface) to define a proposed asset-based token 318. The token design interface 302 may include a token attribute profile interface 332, an asset class attribute profile interface 334, and asset-token link framework profile interface 338, and a token simulator interface 340. The token attribute profile interface 332 enables a user or designer to select a variety of token attributes 304 that will define the token attribute profile 322 of the proposed asset-based token 318. The asset class attribute profile interface 334 enables the user or designer to select a variety of asset class attributes 308 to define the asset class attribute profile 324 of the proposed asset-based token 318. The asset-token link framework profile interface 338 enables a user or designer to select asset-token link framework attributes 310 to define the asset-token link framework 328. framework. The token simulator interface 340 enables a user or designer to view token simulator output 320 from running a token simulator 312 to predict a performance of the proposed asset-based token 318.

The token design interface 302 may allow a user to review a range of token attributes and asset classes attributes and analyze the attributes based on historical analytic datasets, design the properties of a proposed asset-based token 318, including selecting among a set of asset-token link framework attributes 310, and simulate the market behavior of the proposed asset-based token 318. This may be an iterative process as the token attribute profile 322, asset class attribute profile 324, as well as the asset-token link framework 328 may be altered based on one or more results of the simulation.

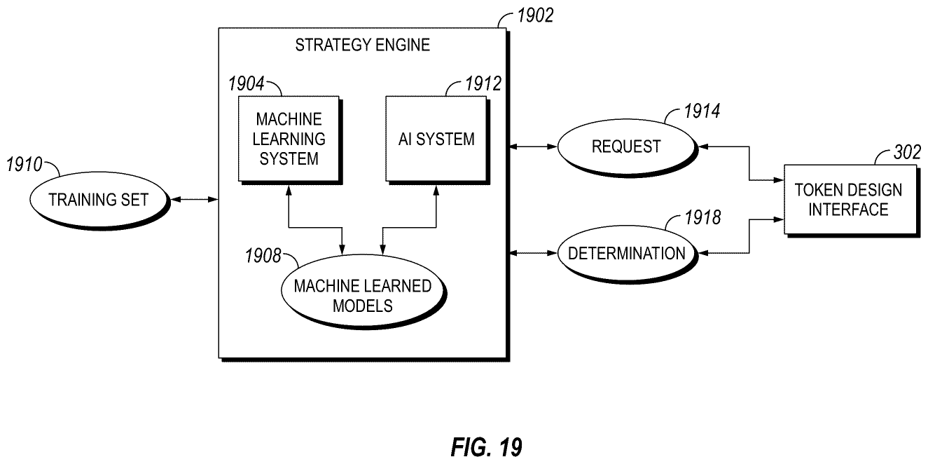

Referring to FIG. 19, another aspect of the invention relates to a strategy engine 1902 that can be engaged through the token design interface 302. In embodiments, the strategy engine 1902 includes a machine learning system 1904 that trains a set of machine-learned models 1908 to output a determination 1918 related to a set of token design strategies employed by a token designer, which is optionally trained using a training data set 1910 comprising at least one of asset class and/or token features, attributes, parameters, and outcomes. In embodiments, the strategy engine includes an artificial intelligence system 1912 that receives a request 1914 for a determination 1918 of a set of asset class attributes that may be configured to support a strategy selected and/or configured by a user and generates a set of asset class recommendations (such as relating asset class types, specific bundles of assets, relative amounts, timing of recommended acquisition or disposition, or the like) regarding a set of asset classes (optionally including a recommended set of tokens that represent, are redeemable for, are indexed to, are linked to, or otherwise are associated with the set of asset classes), such that the recommended actions with respect to the asset classes (and, as applicable, tokens), implement the strategy that is selected and/or configured by the user. The strategy may be specified in the token design interface, simulated in the simulation interface, and the like, such as to display the nature of the association of each asset class/asset class token with an aspect of the strategy. Parameters of the strategy may include specific goals sought by the strategy (e.g., preservation of capital, a desired risk/return profile, accumulation of a specified amount of value (e.g., to meet a defined goal), and the like. Behavior of asset classes in relation to strategies may be simulated, and association of asset class recommendations and simulations with token attributes may include visual representations of historical performance, optionally presented in layers such that aggregate impacts of a set of tokens are represented, with historical and/or forecasted volatility/variance.

In embodiments, the strategy engine 1902 may include a set of predetermined strategies and associated asset classes, such as: (i) asset classes with low historical volatility, guaranteed returns, backing or tethering to underlying value, or the like for capital preservation strategies; (ii) tokens representing returns from speculative asset classes like bonds of emerging countries for more aggressive strategies seeking high returns and accepting higher risk, and (iii) various permutations associated with other strategies, including ones that have predetermined pivot points (e.g., shifting from aggressive-to-conservative as a threshold level of value is accumulated, as the user reaches a certain age, and the like). Preconfigured and/or custom strategies may be selected or designed among many available strategies, such as buy and hold, long/short equity, credit-default swap strategies, asset allocation, intertemporal portfolio choice, pairs trading, swing trading, scalping, day trading, news-based, market timing, social trading, front-running, chart-based, computer-science based, automated/algorithmic, and hybrids and combinations of the foregoing. Custom, hybrid and combined strategies may be supported by sets of tokens representing different aspects needed to support the underlying strategy, such as a security token for a growth equity allocation in a portfolio, an intellectual property royalty stream token or production yield token for a current yield goal in a portfolio, and a real estate token in an emerging market for a speculative value accumulation goal of the token. Each set of tokens may be represented in the analytic interfaces described herein, such as showing historical behavior of the underlying asset class, predicted or simulated behavior (optionally using machine learning or AI operating on historical data sets to forecast behavior), correlations among the asset classes (e.g., to indicate where selected tokens may have underlying economic relationships that tend to increase volatility and/or anticipated returns (e.g., due to reinforcing aspects of two asset classes or that have underlying relationships) or that tend to reduce volatility and/or returns (e.g., where the asset classes/tokens tend to be correlated in ways that hedge risk).

In embodiments, the strategy engine 1902 may be trained over time, such as on a training data set 1910 of token designers and outcomes of tokens on the platform, to take an input strategy, discover a set of asset classes that are candidates to satisfy the strategy, select a set of asset class-linked tokens, generate a plan for acquisition and/or disposition of tokens (and possibly other assets), to execute the strategy, and issue a set of instructions (executable over time) to execute the plan. In embodiments, the strategy engine may be trained, using similar inputs and feedback on outcomes, to monitor and rebalance a set of tokens, including based on market changes (e.g., changes in value of tokens or other assets), changes in strategy (including pre-planned changes and ones that emerge), and/or based on other factors.

In embodiments, a recommendation for a token designer and/or an algorithmically generated plan for token design may include a set of inputs generated by collaborative filtering, such as operating on a set of token designs of other designers and/or a set of token designs generated automatically for a similar strategy, a similar user, or the like. Selection of a cohort for collaborative filtering may be based on similarity attributes of a strategy (e.g., risk/reward profile, goals, timing, preferences for certain asset classes, geography, and many others), similarity attributes of users (e.g., demographic, psychographic, preference, location, age and other factors), and the like. Once a cohort is formed, recommendations may be provided based on the strategies that are favored by the most similar user and/or that are the most similar in attributes. Collaborative filtering recommendations may take into account historical outcomes, such as risk/reward profiles, as well as predictions and simulations as noted above.

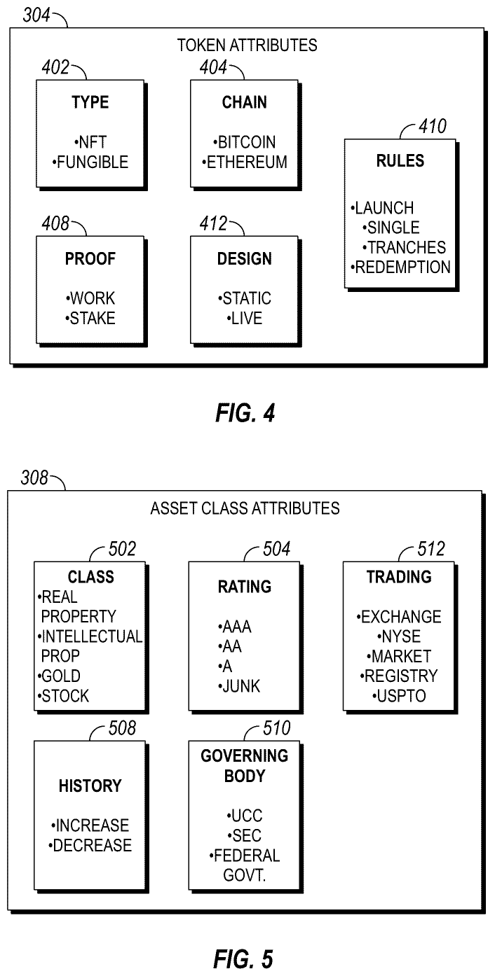

Referring to FIG. 4, token attributes 304 which may be part of the token attribute profile 322 may include media type 402, market rules 410 (e.g., how the tokens may be redeemed, whether the tokens will be launched singularly or tranches), proof 408, token design 412 (e.g., static or live), chain 404 (e.g., bitcoin, Ethereum), and the like and may vary between asset classes. Token attributes 304 may include media and display properties, trading rules, blockchain attributes, consensus algorithm details, tokenomics details, and smart contract options for token handling (including for token launches (e.g., in tranches), burning, redemption, exchange, and the like). A library of reference designs may be accessed by drop-down menus, drag-and-drop, or the like to facilitate rapid generation of new tokens from precedent, selection of different token attributes 304, and the like.

Hybrid-asset tokens may have attributes of multiple asset classes, such as commodities, securities, real-estate, intellectual property baskets, and the like. Asset class attributes 308, which may be part of the token's asset class attribute profiles 324. The asset class attributes 308 may include identifying data (such as what conventional legal and market frameworks govern asset ownership and transfer), historical data on the asset class (including linkages to relevant analytic data sets, such as displaying price and trading volume patterns, volatility, valuation estimates, expert commentary, ratings, and many others), and/or projections or simulations of asset class behavior. Referring to FIG. 5, asset class attributes 308 may include class of attribute 502, asset rating 504, information on historical performance of the asset 508, any governing bodies 510 related to the asset, information regarding current trading mechanisms 512 for the asset, and the like.

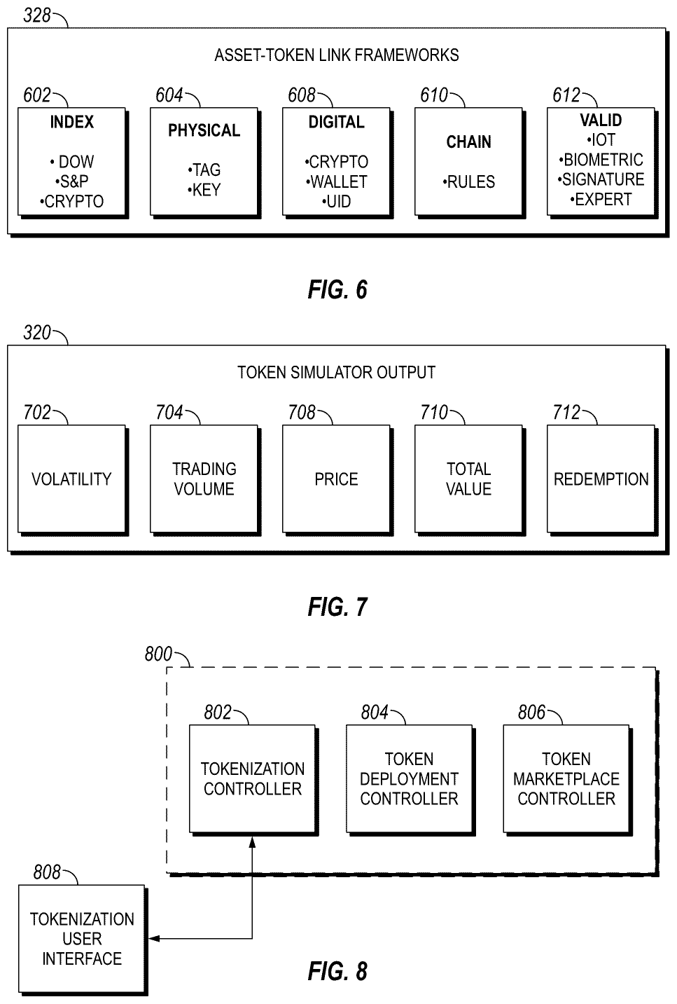

Referencing FIG. 6, an asset-token link framework profile interface 338 may allow a user to select different asset-token link frameworks 328 such as where the asset or token is traded on an index 602 (e.g. DOW, S&P, etc.), whether there is a physical linkage 604 such as an asset tags, whether there are digital linkages 608 between the asset and token such as a user ID, digital wallet, cryptographic linkage and the link. There may be data or rules about an associated block chain 610 and how the asset-token link is validated 612 (e.g. IoT sensors, biometric measurements, signatures, expert authentication, or the like).

An asset-token link framework profile interface 338 may allow a user (e.g., a token designer) to determine how a token will be linked to the asset class, such as through a cryptographic linkage (e.g., between a token and another digital item), through an orchestration system (such as where purchases, sales and other actions relating to the asset class are orchestrated to correspond to actions of tokens, and vice versa), through physical linkages 604 (such as through asset tags), through validation or authentication processes (such as involving sensors or cameras that record actions on the asset class), or combinations of these or other linking frameworks. In embodiments, a user may generate at least one asset class linked token in response to a token link description and an asset class description.

A token simulator 312 may allow a token designer to simulate the market behavior of the proposed asset-based token 318, such as based on historical asset class behavior, historical token trading data, and a set of economic and/or tokenomic analytic models. A token simulator interface 340 may allow a designer to select token simulator parameters to be used by the token simulator 312 when simulating the market behavior of the proposed asset-based token 318. Referring to FIG. 7, token simulator output 320 may include predictions of token volatility 702, token trading volume 704, token price 708, total value 710, information regarding redemption applications 712 as described elsewhere herein, and the like. Redemption applications 712 may be indirect, such as where a token is linked merely by indexing to an underlying asset class or member thereof. In such cases, a smart contract may be defined that takes an index value for the asset class, or member thereof, and calculates a current redemption value of the token (which may be denominated in currency, cryptocurrency, other tokens, points, or other denomination). Upon a signal for redemption (such as in redemption application 712 or interface thereof), the smart contract may execute its calculation, determine the value, and send an instruction to the relevant entity (e.g., an account and/or payments system) to deliver the value to the redeeming user. The smart contract may similarly instruct that the token be “burned” or otherwise rendered unusable once redemption is complete. Redemption may be partial, such as where a portion of funds are delivered and the smart contract associated with the token sets a new value for future redemption(s). Redemption may also be direct, such as where a token represents or embodies access controls. For example, a token may be used to unlock access to a production facility, such as a 3D printer, such that the production of the printer is allocated to the token holder for a stated duration, stated number of units produced, or the like. This may be applied to various production types, such as energy production, materials, farm products, manufacturing lines and the like. As with other redemption, a smart contract may embody and govern redemption rules, such as by tracking incremental or partial redemption, and burning or rendering the token invalid upon complete redemption. Redemption may also trigger account changes, such as transfer of a token on a distributed ledger, in a wallet or the like.

A circuit, as used herein, should be understood broadly. In certain embodiments, components having terminology such as a controller, a component, an engine, a processor, or the like may be utilized instead of, and/or in conjunction with, a circuit, and accordingly those terms should be understood broadly with similar considerations to those presented with regard to circuits. Circuits, as used herein, include correlated aspects of the system configured to perform selected operations thereof, and can include logic gates, programmable logic circuits, interface devices (e.g., network communication devices and/or connecting hardware), I/O devices (e.g., user input devices such as a mouse, keyboard, touch screen, voice input, displays, etc.), any sensor utilized by the system, any actuator utilized by the system, processors or processing resources, computer readable memory, data stored in computer readable memory, data accessed by the system, API interfaces (e.g., to a marketplace, third party service, etc.), or the like. In certain embodiments, aspects of a circuit may be embodied as instructions stored on a computer readable memory configured such that a processor executing the instructions thereby performs one or more operations of the circuit. In certain embodiments, as will be understood in the context of particular descriptions herein, a circuit includes any one or more of these, and/or is in communication with any one or more of these. The present disclosure depicts each controller, circuit, component, engine, memory element, data structure, or the like, as a single device for clarity of the present description. A given controller, circuit, component, engine, memory element, data structure, or the like, may additionally or alternatively be distributed, in whole or part.

Referencing FIG. 8, an example asset linked token trading system 800 for creating asset linked tokens is schematically depicted. The example asset linked token trading system 800 may be utilized with, included with, and/or include, in whole or part, any systems, assemblies, controllers, components, circuits, or the like, as set forth throughout the present disclosure, including at least the platforms and/or systems set forth in relation to FIGS. 1-3. Additionally or alternatively, the asset linked token trading system 800 and/or aspects thereof, may be utilized to perform any methods, operations, and/or procedures set forth throughout the present disclosure. The example asset linked token trading system 800 includes a tokenization controller 802 that implements a tokenization user interface 808, a token deployment controller 804 that implements asset backed token transactions, and a token marketplace controller 806 that implements an asset backed token trading system.

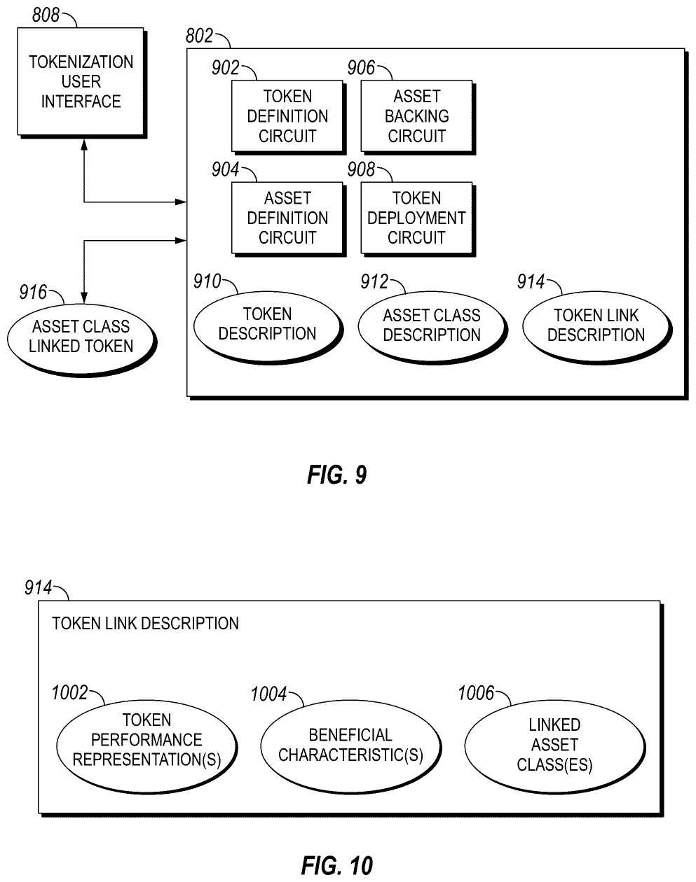

Referencing FIG. 9, an example tokenization controller 802 is schematically depicted. The example tokenization controller 802 includes a token definition circuit 902 that interprets a token description 910 in response to user operations with the tokenization user interface 808, an asset definition circuit 904 that interprets an asset class description 912 in response to user operations with the tokenization user interface 808, and an asset backing circuit 906 that interprets a token link description 914, including a token performance description corresponding to a beneficial characteristic of at least one asset corresponding to the asset class description 912. The example asset backing circuit 906 generates at least one asset class linked token 916 in response to the token link description 914 and the asset class description 912.

In certain embodiments, the token description 910 includes aspects of the token that are set by a user creating the token utilizing the tokenization user interface 808, for example including a name or identifier of the token, a description utilized with the token (e.g., on a marketplace), the purpose of the token, or the like. In certain embodiments, user selections for the token description 910 may be limited by the platform and/or tokenization user interface 808, for example to limit a maximum or minimum initial value for a token, to ensure that certain information about the token is available to potential purchasers (e.g., set by regulations, policies, an administering party for a platform, or the like), and/or may be limited to selections made available by an administering party for the platform (e.g., limited to certain types of assets, certain beneficial characteristics of assets, a limited total number of assets or asset types that can be linked to a token, etc.).

In certain embodiments, the asset class description 912 includes a description of the backing or linked asset, and/or available beneficial characteristics of the asset(s) that can be linked to the token. In certain embodiments, the beneficial characteristics of the asset(s) that can be linked to the token may depend upon the asset itself (e.g., a property based asset may allow linking to rental income, property taxes, and/or insurance collection for a property, where a precious metal based asset may allow linking to distinct characteristics, such as a value, volatility of value, production for a country, specific mine, the entire world, etc., an ore cut for a mine or region, etc.).

In certain embodiments, the token link description 914 includes the backing (or linked) assets or asset classes, amounts of the assets, which beneficial characteristic of the asset(s) are linked to the tokens, and the like. In certain embodiments, the token link description 914 further includes rules governing the token, for example threshold values related to the beneficial characteristics being utilized (e.g., where the performance of the token is modulated based on external factors such as inflation, production capacity, news events, crop yields, elapsed time since the token was created, first acquired, last traded, etc., or the like), and/or changes to the asset-token linkages in response to whichever factors are selected. In certain embodiments, the backing (or link) between the asset (and/or asset class) and the token may be a hard link—for example where the token performance follows the beneficial characteristic of the asset or asset class due to a hard constraint (e.g., ownership of the token is linked to a specific amount of the underlying asset) and/or due to a specific rule (e.g., the performance of the token is guaranteed—for example with another linked token that changes value in response to a failure of the original token performance to strictly follow the beneficial characteristic). In certain embodiments, the backing (or link) between the asset or asset class and the token may be a soft link—for example where the token link and/or rules are configured such that the token performance is expected to follow the beneficial characteristic, but may not match that performance in actual practice. For example, a token linked to the value of an amount of gold may instead be linked to a basket of other precious metals or other assets which tend to follow the price of gold, but which may not precisely follow the price of gold in practice. The nature of the token link description 914 may be indicated with the asset class linked token 916 or not, for example depending upon applicable regulations, policy decisions from an administrator of the platform, selections by the user creating the token, or the like. For example, a published asset linked token(s) 1108 presented for offer on a marketplace may include information about which assets or asset classes are linked to the token, whether the link is a hard or constrained link, or a soft link, and what rules are applicable to the token to enforce the link to the asset or asset class, including which thresholds, data, or events apply to the token, and/or how the link is expected or scheduled to change over time (e.g., for a token with characteristics such as value tracking, volatility tracking, risk tracking, etc., that change in a known or planned manner over time, with respect to certain events or metrics, or the like). In certain embodiments, the token link description 914 associates specific assets and/or asset classes with the token—for example a revenue stream of a particular farm or hotel, which may also change over time (e.g., switching which farms are linked based on season, etc.). In certain embodiments, the token link description 914 does not associate specific assets with the token—for example a token backed by a fungible asset, an asset class, and/or a token linked to a derivative asset (e.g., a basket of farms, intellectual property, or the like). In certain embodiments, the token link description 914 is exhaustible in whole or part, for example with an asset that is consumable in fact (e.g., a consumable asset such as a specific stored crop, oil, or the like) and/or consumable in a logical sense (e.g., an intellectual property asset allowing for a specific number of uses, a number of users, a number of installations, etc.). In certain embodiments, the token link description 914 is associated with a number of assets or asset classes that may change over time, for example a token representing a group of subscriptions (and/or a revenue stream of the subscriptions), a number of license seats, or the like.

Referencing FIG. 10, an example token link description 914 is schematically depicted. The example token link description 914 includes a token performance representation 1002 corresponding to a beneficial characteristic 1004 of a linked asset(s) 1006. The linked asset(s) 1006 may any type of asset including, without limitation, any type of asset as set forth throughout the present disclosure. Example and non-limiting linked asset(s) 1006 include: a precious metal asset (e.g., gold, silver, platinum, a precious metal index, and/or a combination of metals); an asset pre-cursor (e.g., a planted crop, revenue stream for an asset under construction, produced ore from a mine before processing, etc.); a fiat currency (e.g., a sovereign currency based asset); a real estate asset (e.g., a property, revenue associated with a property, residual value from a sale or disposition of a property, etc.); a financial asset (e.g., a financial instrument, a contract and/or revenue associated with a contract, and/or a dividend associated with a security or other financial instrument); a security asset (e.g., a secured instrument such as a stock, bond, or associated benefit or revenue therefrom); an intellectual property asset (e.g., revenue associated with an element of IP such as a copyrighted work, a group of subscriptions and/or revenue therefrom, a right to utilize an IP element, such as a copyrighted work, manufacturing instruction set, or the like, etc.); a production asset (e.g., a crop from a farm, an output of a manufacturing facility, and/or revenue generated therefrom); a beneficiary asset of any one or more of the foregoing (e.g., a contingent or residual right to any of these, for example based upon the occurrence of certain events, elapsed time, or the like); and/or a derivative asset of any one or more of the foregoing (e.g., a packaged and/or securitized version of any of the foregoing, such as a share of revenue from a group of manufacturing facilities, manufactured assets under a certain license, etc.). In certain embodiments, a linked asset(s) 1006 may be a combination of these—for example a share of license revenue from an IP license to manufacture a specific object, combined with a license to manufacture a set number of units of the specific object. In certain embodiments, combined assets may be of a similar nature—for example a revenue share associated with licensed seeds as well as a harvested crop revenue for a particular farm, or of a dissimilar nature—for example an asset (or asset class) linked to a precious metal asset combined with an asset linked to a dividend from a particular stock. The utilization of similar and/or dissimilar assets linked to and/or backing a token allows for separate tuning of the token performance representation 1002 from the beneficial characteristics 1004—for example allowing the asset class linked token 916 to follow the value of an asset with lower volatility, with leveraged (or deleveraged) movement of the value, or the like. In certain embodiments, the utilization of multiple linked asset(s) 1006 allows for generation of tokens that have specific selected responses to events, such as a weather event occurring that may affect a crop, housing prices, or the like, that may be relevant to particular users or classes of users, and that are not linked in the general economic system.

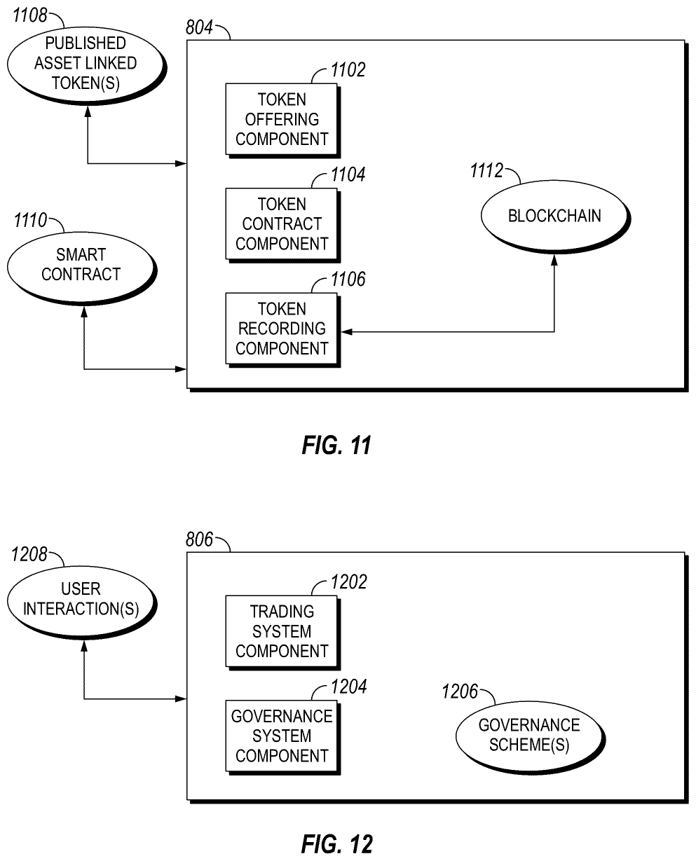

Referencing FIG. 11, an example token deployment controller 804 is schematically depicted. The example token deployment controller 804 includes a token offering component 1102 that publishes the exposed asset class linked token(s), for example based on the asset class linked token 916 exposed by the token deployment circuit 908, and provided as a published asset class linked token(s) 1108, to a token marketplace system (e.g., operated by the token marketplace controller 806). In certain embodiments, the asset class linked token 916 is published upon creation, where operations of the token deployment controller 804 are performed by the token deployment circuit 908. In certain embodiments, for example where an administrator of the token marketplace chooses to verify and/or otherwise approve tokens before they are published, and/or where publication control is provided to allow the user to offer an asset class linked token 916 to only some users and/or to a selected group of users, the token offering component 1102 performs the publication of the asset class linked token(s) 1108. The published asset class linked token(s) 1108 may be listed on an interface, for example a market operated on a website, web portal, mobile application, or the like, and/or the published asset class linked token(s) 1108 may be recorded on a blockchain 1112 or other ownership and/or transfer recordal system, thereby being made available to users having access to the market and/or blockchain 1112. The example token deployment controller 804 includes a token contract component 1104 that executes a smart contract 1110 to acquire the published asset class linked token(s) 1108—for example in response to user selections to acquire the published asset class linked token(s) 1108, and/or in response to user rules set up to automatically acquire tokens having certain characteristics (e.g., price, expected value, volatility description(s), liquidity description(s), etc.). In certain embodiments, the smart contract 1110 performs in any manner as set forth throughout the present disclosure, including binding the parties (e.g., the creator and/or previous owner of the token, and the acquirer of the token) to the terms and conditions related to the token. The terms and conditions related to the token may be created as a part of the token description 910, and/or according to terms applied by an administrator of the token marketplace. The example token deployment controller 804 includes a token recording component 1106 that records transaction of the published token(s) 1108 in response to the executed smart contract 1110, for example by appending the transaction onto the blockchain 1112, recording the transaction in a secured database, or the like. In certain embodiments, for example where transactions are not executed using a smart contract 1110, the operations of the token recording component 1106 are performed in response to a received indication that a transaction has occurred, for example based on a notification or transaction value received from the token marketplace controller 806 in response to user operations of token creators, buyers, and/or sellers.

Referencing FIG. 12, an example token marketplace controller 806 is schematically depicted. The example token marketplace controller 806 includes a trading system component 1202 that makes the published asset class linked token(s) 1108 available to at least a portion of users of the asset linked token trading system 800, for example all users, selected users (e.g., positively selected users, users associated with a particular entity, users associated with a particular sub-market of the marketplace, etc.), and/or a rule-based selection of users (e.g., users meeting a certain asset threshold, subscribing users, users performing certain searches such as using certain keywords in a search, and/or users that have performed transactions for certain types of tokens and/or related to certain types of assets or asset classes). The example trading system component 1202 further accepts user inputs for transactions (e.g., as user interactions 1208) of the published asset class linked token(s) 1108, including at least user interactions 1208 to search for tokens, to access tokens, to make tokens available for discovery and/or trading, to offer tokens for trading, and/or to purchase tokens.

The example token marketplace controller 806 includes a governance system component 1204 that performs operations to support governance scheme(s) 1206 for the asset class linked token(s) 1108, including operations that may regulate aspects of generating the tokens, publishing the tokens, offering the tokens, purchasing the tokens, and/or maintaining the tokens. The governance scheme(s) 1206 may include regulatory components (e.g., with respect to applicable laws for the tokens and/or entities offering and/or purchasing tokens), policy components (e.g., to ensure that policies by offering parties, transacting parties, an administrator of the token marketplace, and/or an administrator of assets or asset classes linked to tokens—such as a listing company, exchange, or the like) that are to be implemented and/or maintained with respect to the tokens. In certain embodiments, the applicable governance scheme(s) 1206 may depend, in whole or part, on the mix of assets or asset classes linked to a particular token, on the nature of an entity offering and/or purchasing a token (e.g., size, investor class, indicated preferences, certifications, etc.), on a jurisdictional location of an aspect of the marketplace or transaction (e.g., a location of an administrator of the marketplace, a location of a server of the marketplace, a location of an offering entity, a location of a purchasing entity, and/or a location of a linked asset and/or asset class). As the linking of a particular token can change over time, and as relevant parties to the token may change over time (e.g., due to transactions of the token, and/or changes in the relevant party away from the marketplace, such as in a sale or merger of an entity), the relevant governance scheme(s) 1206 for a token may also change over time. In certain embodiments, the governance system component 1204 performs one or more operations such as: adjusting the token link description 914 in response to the governance scheme(s) 1206 associated with the asset class description 912, and/or confirming the token link description 914 (e.g., confirmation that attributes and descriptions of the token remain compliant, and/or confirming that appropriate notifications, acknowledgments, or the like have been completed). In certain embodiments, the governance system component 1204 may provide notifications to entities, remove tokens from listing or publication, and/or operate user interfaces to provide governance information to users, and/or to get acknowledgements from users, in response to the applicable governance scheme(s) 1206 and/or changes to the token, relevant entities, transactions with the token, and/or changes to the governance scheme(s) 1206 itself (e.g., changes in regulations, laws, policies, or the like). In certain embodiments, changes to the token—for example which assets or asset classes are linked, and the mix thereof, may also involve operations of the governance system component 1204 to ensure that the token, marketplace, and users of the marketplace, remain compliant with the applicable governance scheme(s) 1206.

The terms asset backed token, asset-backed token, asset class backed token, and/or asset class linked token, as used herein, should be understood broadly. Tokens of the present disclosure are cryptographically secure elements that can be held, traded, or otherwise exercised as a digital property. Tokens may be managed, held, and/or traded using any secure digital backbone for managing ownership and access, for example using digital certificates or a blockchain for recording transactions. In certain embodiments, a token may represent a single unit of ownership, ownership of multiple units, and/or ownership of share of a unit. Without limitation to any other aspect of the present disclosure, a token as utilized herein operates in a similar manner to a cryptocurrency asset, may be a cryptocurrency asset, and/or may include one or more cryptocurrency assets as a part, or all, of the assets or asset classes backing the token and/or linked with the token. An asset class linked token may be referenced as an asset backed token, an asset class backed token, an asset linked token, and/or other similar terminology herein. An asset class linked token represents and/or is linked with a beneficial characteristic of another asset, or a class of assets, that is distinct from the token itself. For example, an asset class linked token may be generated to follow the risk profile, volatility, liquidity, value trajectory, value offset profile (e.g., relative to inflation or another dynamic indicator), or the like, of a particular asset (e.g., an identifiable asset such as a particular farm, production facility, or the like) or an asset class (e.g., gold, soybeans, oil, real estate in California, real estate in downtown Manhattan, net income for a basket of companies in a particular industry, etc.). In certain embodiments, even where an identifiable asset is linked to the asset class linked token, the identifiable assets may be changed over time—for example due to operations of linking rules for the token over time and/or in response to certain events.

The term beneficial characteristic, as utilized herein, should be understood broadly. A beneficial characteristic is a characteristic that is dependent upon the underlying asset. Thus, a token that has a performance (e.g., as a token performance representation) corresponding to the beneficial characteristic of an asset (and/or asset class) is a token created to have a performance that follows, in some sense, the performance of that characteristic of the asset and/or asset class. For example, if the beneficial characteristic of the asset is the asset value, a token created to have a performance linked to that beneficial characteristic will have a value that follows the asset value. In certain embodiments, a token may have a performance corresponding to more than one beneficial characteristic of an asset or asset class (e.g., an asset value, asset volatility, asset liquidity, etc.), and/or corresponding to one or more beneficial characteristics of more than one asset or asset class (e.g., a token having a performance corresponding to a value of an amount of a gold asset, and further corresponding to a revenue stream of a production asset). Without limitation to any other aspect of the present disclosure, a performance that corresponds to a beneficial characteristic may be a performance that matches the beneficial characteristic (e.g., if the linked asset doubles in value, then the token doubles in value), and/or that has a selected function relative to the beneficial characteristic (e.g., that is scaled relative to the beneficial characteristic, such as 1.5x, 2x, 0.5x, etc.; that is offset relative to the beneficial characteristic, such as x+0.5, x−1.0, etc.; and/or that has a more complex relationship to the beneficial characteristic, such as matching, scaling, and/or offsetting from the beneficial characteristic depending upon the value or performance of the beneficial characteristic itself—for example matching value returns up to 5%, and utilizing a different function such as doubling returns or halving returns above 5%, for example by adjusting a leveraging of the token based on the value returns, and which may be performed for any reason such as limiting losses, maximizing gains, adjusting volatility, or the like). In certain embodiments, a token may have a performance that corresponds to a number of beneficial characteristics in any manner, for example having fractionated performance (e.g., 25% like beneficial characteristic A, and 75% like beneficial characteristic B), priority based performance (e.g., following beneficial characteristic A under certain conditions, and following beneficial characteristic B under other conditions), and/or a weighted or cost-based performance (e.g., using a scoring function with regard to beneficial characteristic A, another scoring function with regard to beneficial characteristic B, where the token performance is tuned to maximize, incrementally improve, and/or enforce thresholds for the overall score value from the scoring functions).

Embodiments herein can thereby be utilized to tune the performance of a token based on underlying asset(s) that have independent value, creating a token that has the selected performance characteristics based on the selected characteristics of the underlying asset(s), with ownership and trading of the token grounding the performance to give the user leverage to exercise the benefits of the token for the selected purpose. Embodiments herein allow for token creators, holders, and traders, to perform numerous real world operations that cannot be done utilizing previously known instruments. For example, a token may be configured to follow the value of a first asset, and to emulate the volatility of a second asset. In another example, a token may be configured to trade a value related to an asset that is not tradeable in previously known systems, for example to trade on a portion of a revenue stream from an asset, or a more complex operation such as trading on a selectable portion of the revenue stream, such as amounts of the revenue stream exceeding a static (e.g., amounts exceeding $1,000,000 per year) or dynamic (e.g., amounts exceeding 8% net profit) threshold of the revenue stream of an asset. Embodiments herein also provide for a convenient interface to create and execute such tokens, where similar options for attaching to and/or following an aspect of an asset would previously require complex and highly specialized agreements between multiple parties to execute similar capability. Embodiments herein also provide for enhanced liquidity, allowing for parties to engage and trade in otherwise complex arrangements without having to negotiate terms of agreement, and allowing numerous parties, including potentially any party having access to a trading marketplace for asset class linked tokens, to trade assets with a low burden of entry, reduced cost of creating and maintaining arrangements, and/or improving liquidity of tokens by facilitating the creation, publication, and transactions of the tokens). Embodiments herein provide technical tools that allow for configured arrangements that can facilitate the creation and execution of projects, investments, and/or trading arrangements that would otherwise be unavailable due to a lack of previously available tools to manage risks, distribute investments throughout a sufficiently sized investor pool, and/or provide sufficient protection and transparency for returns on investment for those projects, investments, and/or trading arrangements.

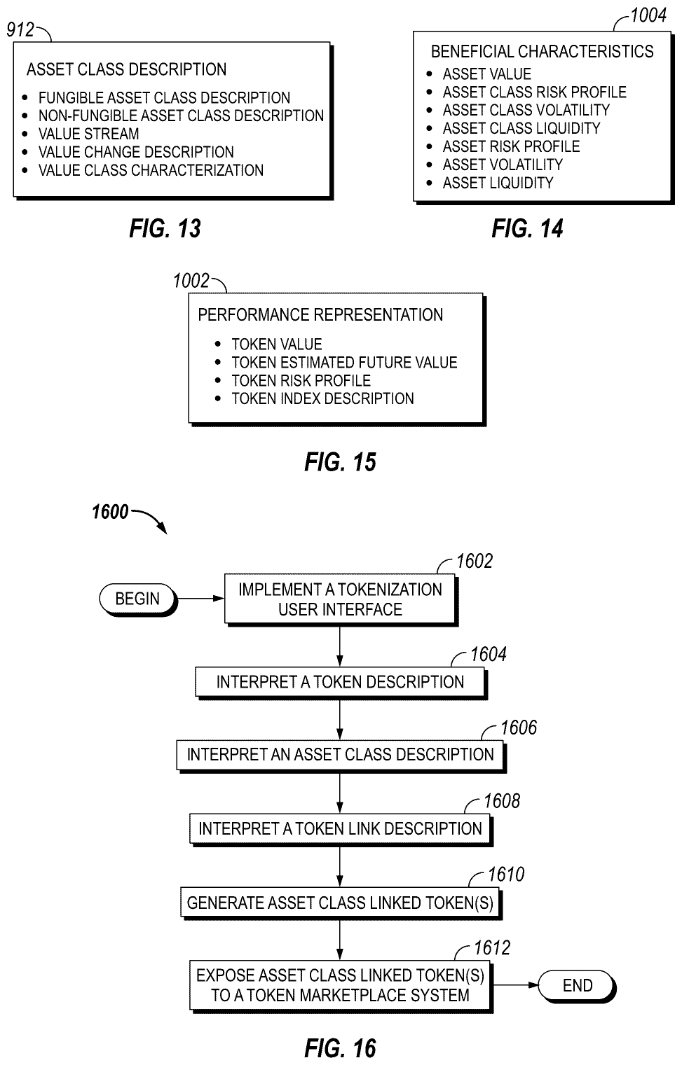

Referencing FIG. 13, an example asset class description 912 is schematically depicted. The asset class description 912 may be determined in response to user entries on a tokenization user interface 808, and/or may further be determined in response to default values, values determined according to a governance scheme(s) 1206, preferences indicated generally by a user, and/or values determined according to rules set by an administrator of the tokenization controller 802. In certain embodiments, the type of assets or asset classes in the asset class description 912 may be utilized to adjust or constrain any of these (e.g., listing a particular asset or asset class may invoke a set of default values, rules, etc.). The asset class description 912 may be stored in a data structure, including potentially in a blockchain (e.g., the same or a distinct blockchain from one utilized to record transactions of tokens, such as blockchain 1112), or the like. In certain embodiments, the asset class description 912 may be stored locally (e.g., on a user device that is performing operations to generate a token), and/or may not be stored, for example where the asset class description 912 is created and utilized for a published asset class linked token(s) 1108 in a single workflow, where the asset class description 912 is utilized to generate a token and then discarded. In certain embodiments, an asset class description 912 or portions thereof may be stored, for example to support generating a token over multiple sessions, and/or to re-use all or a portion of an asset class description 912 for later use in generating another token using the same asset or asset class. The example asset class description 912 includes a fungible asset description (e.g., for assets or asset classes based on fungible assets), a non-fungible asset description (e.g., for assets or asset classes based on non-fungible and/or identifiable assets), a value stream (e.g., allowing linking of tokens to a revenue stream, capitalization associated with an asset—which may vary over time, or the like), a value change description (e.g., allowing linking of tokens to changes in an asset value relative to a baseline, whether the asset value is a total value or a value stream), and/or a value class characterization (e.g., allowing linking of tokens to a rating or quality of an asset or asset class, to a compliance with requirements for the asset or asset class; for example compliance requirements may relate to storage, maintenance, inspections, location, security, etc., where failure to meet compliance and/or results of compliance performance, such as inspection results, may affect the value of the asset or asset class).

Referencing FIG. 14, an example beneficial characteristic 1004 is schematically depicted. The example beneficial characteristic 1004 allows for a token, in whole or part, to have a dependency upon a selected characteristic of linked assets or asset classes. Example and non-limiting beneficial characteristics 1004 include one or more of: an asset value, an asset risk profile, an asset volatility (e.g., the tendency for value changes and/or value change fluctuations within a selected time period, and/or statistical descriptions of these, which may be determined against any value dimension of the asset or asset class, such as sale value, collateral value, revenue stream value, or the like), an asset liquidity (e.g., a description of how likely the underlying asset or asset class can be sold, purchased, or the like, including a time factor—how long a transaction is expected to take, a pricing factor—how much variability in price may be expected relative to a market price, a market size factor—e.g., how many potential sellers and/or purchasers are likely to be available, and/or which may further include a function of these with respect to a volume, for example a token that is likely to involve 10,000 units of an asset may have a different liquidity characteristic than a token that is likely to involve 1,000 units of that same asset). In certain embodiments, the beneficial characteristic 1004 may depend upon the entity that is generating the token, for example an entity that is a primary producer of an asset class (e.g., a precious metal mining company) generating a token that is linked to a large quantity of a precious metal asset may be expected to have a different effect on the market (e.g., reflected as an adjustment to the asset value, volatility, liquidity, etc.) than another entity that is a primary consumer of the asset class (e.g., a high grade electrical connector company). In certain embodiments, the token performance representation 1002 (e.g., reference FIG. 15) associated with the token may reflect the target offeror and/or acquirer for a token, for example with a performance of the token tuned for a particular type of holder for the token. In certain embodiments, a beneficial characteristic 1004 may additionally or alternatively include an asset class value, asset class risk profile, asset class volatility, and/or asset class liquidity.

Referencing FIG. 15, an example token performance representation 1002 is schematically depicted. In certain embodiments, the token performance representation 1002 reflects the intended performance of the token (e.g., 8% rate of return, XX volatility index, YY liquidity index, etc.). In certain embodiments, the token performance representation 1002 reflects the expected performance of the token. In certain embodiments, a user interacting with the tokenization user interface 808 utilizes both of these—for example setting intended performance values for the token, and adjusting the asset class description 912 and/or beneficial characteristics 1004 of linked assets until the expected performance of the token matches, or is sufficiently close, to the intended performance values. In certain embodiments, the tokenization controller 802 populates recommended assets and/or asset classes based on the intended performance for the token, making it convenient for a user to adjust the linking mix of assets and/or asset classes to achieve the intended performance. In certain embodiments, the token performance representation 1002 is utilized to adjust (e.g., by the asset backing circuit 906) the asset/asset class linking mix after the token is generated, published, and/or traded, for example according to rules as described throughout the present disclosure. Example and non-limiting aspects of the token performance representation 1002 include one or more of: a token value (e.g., a value of the token, a value progression of the token, and/or a value description such as a rate of return, net present value, etc.), a token estimated future value (e.g., any of the value parameters at a selected future time, over a selected range of future times, a perpetual value progression target, etc.), a token risk profile (e.g., relative to any selected risk, such as a volatility risk, liquidity risk, total value loss risk, risk relative to a threshold value such as a minimum rate of return, minimum value, etc.), and/or a token index description (e.g., a token that tracks a present or future mix of assets, a present or future scoring parameter such as a mix of investment return, liquidity, volatility, etc., and/or a token that changes performance targets over time, and/or in response to events, in a selected manner, such as: having a first return/risk profile at a first time, and a second return/risk profile at a later time; having a first return/risk profile before a first event such as a weather incident, start of production for a facility, or the like, and a second return/risk profile after the event; a token linked to a first asset class mix at a first time and linked to a second asset class mix at a second time; and/or trajectories of these).

Referencing FIG. 16, an example procedure 1600 to generate an asset class linked token is schematically depicted. Operations of the procedure 1600 may be performed by any components, controllers, circuits, or the like as set forth herein, including at least components of the platform set forth in relation to FIGS. 1-3, and the controllers set forth in relation to FIGS. 8-9 and 11-12. The example procedure 1600 includes an operation 1602 to implement a tokenization user interface, an operation 1604 to interpret a token description, an operation 1606 to interpret an asset class description, and an operation 1608 to interpret a token link description. The example procedure 1600 further includes an operation 1610 to generate an asset linked token(s) in response to the token description, the asset class description, and/or the token link description. The example procedure 1600 further includes an operation 1612 to expose the asset linked token(s) to a token marketplace system, which may be published (e.g., offered) for trading on the token marketplace system.

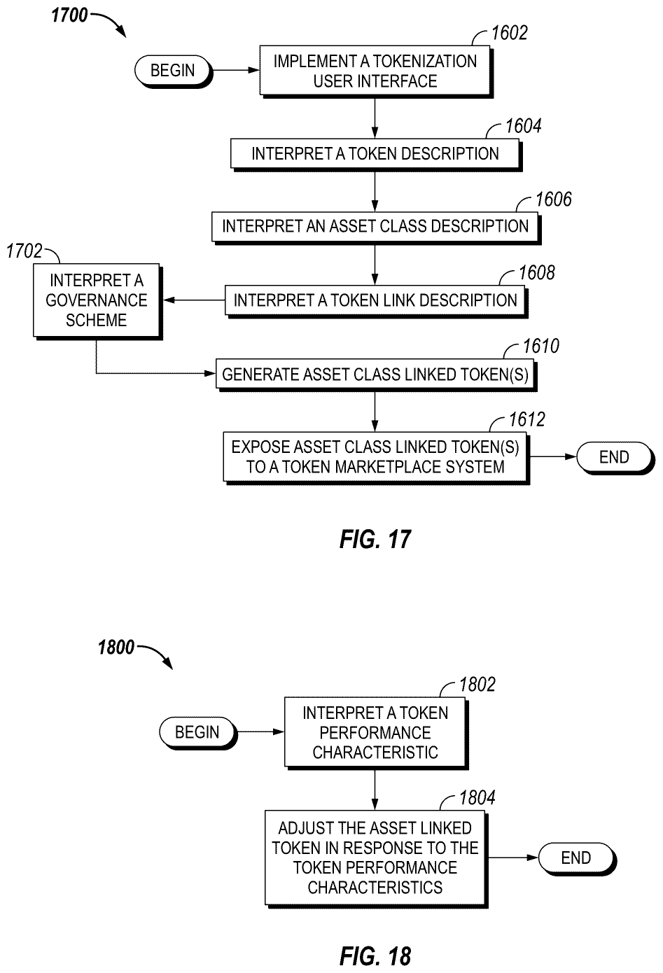

Referencing FIG. 17, an example procedure 1700 for generating an asset linked token is schematically depicted. The example procedure 1700 is similar to procedure 1600, but further includes operations to implement a governance scheme for asset linked tokens. The example procedure 1700 includes an operation 1702 to interpret a governance scheme, where operation 1610 to generate the asset linked token(s) is further performed in response to the governance scheme—for example ensuring that the generated token is compliant with the governance scheme, and/or includes linking rules to enforce the governance scheme over the life cycle of the token.

Referencing FIG. 18, an example procedure 1800 to adjust an asset linked token is schematically depicted. Operations for procedure 1800 may be performed in relation to generated tokens, published tokens, and/or tokens that are already held by acquiring entities, for example through operations with the token marketplace. The example procedure 1800 includes an operation 1802 to interpret a token performance characteristic, and an operation 1804 to adjust the asset linked token (e.g., adjusting a mix of linked assets or asset classes) in response to the token performance characteristics.

The various embodiments envision a microservices architecture with many platform components that correspond to the many components disclosed herein for many different lending use cases.

In embodiments, various use cases include the platform being a general purpose provider across asset classes to back tokens including precious metal-backed tokens, fiat currency backed tokens, real estate backed tokens, and IP-backed tokens (for large IP holders—patents; royalties; brand; publicity rights). In these embodiments, the platform can further leverage blockchain for knowledge functionality as described elsewhere in this disclosure and the documents incorporated by reference herein.

In embodiments, an asset-backed token may comprise a token that represents a specific production capacity of a machine or system, such as the energy produced by a generator or turbine, such that the token holder may buy, sell, redeem, lend, borrow (such as using the token as collateral) or undertake other transactions that involve the token as a representation of the nominal and/or actual physical capacity of the machine. The token, as with other tokens referenced herein, may be for a fractional share of the production, which may be a fungible fractional share or a non-fungible fractional share (such as representing a specific time period of production and/or a specific amount of capacity, such as the production of a given unit amount of energy. Production capacity may involve all kinds of productions, including energy production, heat production, material production, goods production, services production (where machines or systems produce services, such as in an “as-a-service” business model, and many others.

In embodiments, methods and systems herein include a platform for enabling transactions wherein a set of tokens is generated and linked to an alternative asset class, such that the value of a token in the set represents a defined unit of the alternative asset class.

In embodiments, methods and systems herein include a platform for enabling transactions wherein a set of tokens is generated and linked to an alternative asset class, such that the value of a token in the set represents a defined unit of the alternative asset class, wherein the token is a non-fungible token that represents a specific unit of the alternative asset class.

In embodiments, methods and systems herein include a platform for enabling transactions wherein a set of tokens is generated and linked to an alternative asset class, such that the value of a token in the set represents a defined unit of the alternative asset class wherein a token is a fungible token that represents an amount of the alternative asset class.

In embodiments, methods and systems herein include a platform for enabling transactions wherein a set of tokens is generated and linked to an alternative asset class, such that the value of a token in the set represents a defined unit of the alternative asset class wherein a token represents an indexed value of the alternative asset class

In embodiments, methods and systems herein include a platform for enabling transactions wherein a set of tokens is generated and linked to an alternative asset class, such that the value of a token in the set represents a defined unit of the alternative asset class wherein the set of tokens represent fractional ownership interests of units of the alternative asset class.

In embodiments, methods and systems herein include a platform for enabling transactions wherein a set of tokens is generated and linked to an alternative asset class, such that the value of a token in the set represents a defined unit of the alternative asset class, wherein the alternative asset class is one or more of a data stream, a revenue stream, an energy stream, a future income stream, a future production capacity, a future intellectual property capacity, and a future or derivative of any of the foregoing.

In embodiments, methods and systems herein include a platform for enabling transactions wherein a set of tokens is generated and linked to an alternative asset class, such that the value of a token in the set represents a defined unit of the alternative asset class is a blended asset class of at least two assets among a data stream, a revenue stream, an energy stream, a future income stream, a future production capacity, a future intellectual property capacity, and a future or derivative of any of the foregoing.

In embodiments, methods and systems herein include a platform for enabling transactions wherein a set of tokens is generated and linked to an alternative asset class, such that the value of a token in the set represents a defined unit of the alternative asset class, having a set of interfaces for designing a token that represents a set of alternative assets that are blended by a user of the interface to provide a targeted risk/return profile.

In embodiments, methods and systems herein include a platform for enabling transactions wherein a set of tokens is generated and linked to an alternative asset class, such that the value of a token in the set represents a defined unit of the alternative asset class, having a digital twin system for representing a set of parameters of the tokens and the alternative assets that back the tokens.

In embodiments, methods and systems herein include a platform for enabling transactions wherein a set of tokens is generated and linked to an alternative asset class, such that the value of a token in the set represents a defined unit of the alternative asset class, having a data collection system for automatically collecting information about the alternative assets that back the tokens.

In embodiments, methods and systems herein include a platform for enabling transactions wherein a set of tokens is generated and linked to an alternative asset class, such that the value of a token in the set represents a defined unit of the alternative asset class, having an analytic system for calculating and outputting a set of measures that represent parameters of the alternative assets that back the tokens, wherein the measures represent one or more of a price, a value, a volatility, a risk measure, a trading measure, a future price, an option price, and a derivative price.

In embodiments, methods and systems herein include a platform for enabling transactions wherein a set of tokens is generated and linked to an alternative asset class, such that the value of a token in the set represents a defined unit of the alternative asset class, having an analytic system for calculating and outputting a set of measures that represent parameters of the tokens, wherein the set of measures includes one or more of a token price, a token value, a token volatility, a token trading velocity, a token future price, a token risk measure, a token derivative price, and a token option price.

In embodiments, methods and systems herein include a platform for enabling transactions includes a NFT or other token for a stream of energy from a specific asset. In embodiments, provided herein is a platform for enabling transactions wherein a set of tokens is generated and linked to an alternative asset class, such that the value of a token in the set represents a defined unit of the alternative asset class. In embodiments, provided herein is a platform for enabling transactions wherein a set of tokens is generated and linked to an alternative asset class, such that the value of a token in the set represents a defined unit of the alternative asset class and wherein a set of tokens is generated and linked to an alternative asset class, such that the value of a token in the set represents a defined unit of the alternative asset class, wherein the token is a non-fungible token that represents a specific unit of the alternative asset class. In embodiments, provided herein is a platform for enabling transactions wherein a set of tokens is generated and linked to an alternative asset class, such that the value of a token in the set represents a defined unit of the alternative asset class and wherein a set of tokens is generated and linked to an alternative asset class, such that the value of a token in the set represents a defined unit of the alternative asset class wherein a token is a fungible token that represents an amount of the alternative asset class. In embodiments, provided herein is a platform for enabling transactions wherein a set of tokens is generated and linked to an alternative asset class, such that the value of a token in the set represents a defined unit of the alternative asset class and wherein a set of tokens is generated and linked to an alternative asset class, such that the value of a token in the set represents a defined unit of the alternative asset class wherein a token represents an indexed value of the alternative asset class. In embodiments, provided herein is a platform for enabling transactions wherein a set of tokens is generated and linked to an alternative asset class, such that the value of a token in the set represents a defined unit of the alternative asset class and wherein a set of tokens is generated and linked to an alternative asset class, such that the value of a token in the set represents a defined unit of the alternative asset class wherein the set of tokens represent fractional ownership interests of units of the alternative asset class. In embodiments, provided herein is a platform for enabling transactions wherein a set of tokens is generated and linked to an alternative asset class, such that the value of a token in the set represents a defined unit of the alternative asset class and wherein a set of tokens is generated and linked to an alternative asset class, such that the value of a token in the set represents a defined unit of the alternative asset class, wherein the alternative asset class is one or more of a data stream, a revenue stream, an energy stream, a future income stream, a future production capacity, a future intellectual property capacity, and a future or derivative of any of the foregoing. In embodiments, provided herein is a platform for enabling transactions wherein a set of tokens is generated and linked to an alternative asset class, such that the value of a token in the set represents a defined unit of the alternative asset class and wherein a set of tokens is generated and linked to an alternative asset class, such that the value of a token in the set represents a defined unit of the alternative asset class is a blended asset class of at least two assets among a data stream, a revenue stream, an energy stream, a future income stream, a future production capacity, a future intellectual property capacity, and a future or derivative of any of the foregoing. In embodiments, provided herein is a platform for enabling transactions wherein a set of tokens is generated and linked to an alternative asset class, such that the value of a token in the set represents a defined unit of the alternative asset class and wherein a set of tokens is generated and linked to an alternative asset class, such that the value of a token in the set represents a defined unit of the alternative asset class, having a set of interfaces for designing a token that represents a set of alternative assets that are blended by a user of the interface to provide a targeted risk/return profile. In embodiments, provided herein is a platform for enabling transactions wherein a set of tokens is generated and linked to an alternative asset class, such that the value of a token in the set represents a defined unit of the alternative asset class and wherein a set of tokens is generated and linked to an alternative asset class, such that the value of a token in the set represents a defined unit of the alternative asset class, having a digital twin system for representing a set of parameters of the tokens and the alternative assets that back the tokens. In embodiments, provided herein is a platform for enabling transactions wherein a set of tokens is generated and linked to an alternative asset class, such that the value of a token in the set represents a defined unit of the alternative asset class and wherein a set of tokens is generated and linked to an alternative asset class, such that the value of a token in the set represents a defined unit of the alternative asset class, having a data collection system for automatically collecting information about the alternative assets that back the tokens. In embodiments, provided herein is a platform for enabling transactions wherein a set of tokens is generated and linked to an alternative asset class, such that the value of a token in the set represents a defined unit of the alternative asset class and wherein a set of tokens is generated and linked to an alternative asset class, such that the value of a token in the set represents a defined unit of the alternative asset class, having an analytic system for calculating and outputting a set of measures that represent parameters of the alternative assets that back the tokens, wherein the measures represent one or more of a price, a value, a volatility, a risk measure, a trading measure, a future price, an option price, and a derivative price. In embodiments, provided herein is a platform for enabling transactions wherein a set of tokens is generated and linked to an alternative asset class, such that the value of a token in the set represents a defined unit of the alternative asset class and wherein a set of tokens is generated and linked to an alternative asset class, such that the value of a token in the set represents a defined unit of the alternative asset class, having an analytic system for calculating and outputting a set of measures that represent parameters of the tokens, wherein the set of measures includes one or more of a token price, a token value, a token volatility, a token trading velocity, a token future price, a token risk measure, a token derivative price, and a token option price.

In embodiments, provided herein is a platform for enabling transactions wherein a set of tokens is generated and linked to an alternative asset class, such that the value of a token in the set represents a defined unit of the alternative asset class, wherein the token is a non-fungible token that represents a specific unit of the alternative asset class. In embodiments, provided herein is a platform for enabling transactions wherein a set of tokens is generated and linked to an alternative asset class, such that the value of a token in the set represents a defined unit of the alternative asset class, wherein the token is a non-fungible token that represents a specific unit of the alternative asset class and wherein a set of tokens is generated and linked to an alternative asset class, such that the value of a token in the set represents a defined unit of the alternative asset class wherein a token is a fungible token that represents an amount of the alternative asset class. In embodiments, provided herein is a platform for enabling transactions wherein a set of tokens is generated and linked to an alternative asset class, such that the value of a token in the set represents a defined unit of the alternative asset class, wherein the token is a non-fungible token that represents a specific unit of the alternative asset class and wherein a set of tokens is generated and linked to an alternative asset class, such that the value of a token in the set represents a defined unit of the alternative asset class wherein a token represents an indexed value of the alternative asset class. In embodiments, provided herein is a platform for enabling transactions wherein a set of tokens is generated and linked to an alternative asset class, such that the value of a token in the set represents a defined unit of the alternative asset class, wherein the token is a non-fungible token that represents a specific unit of the alternative asset class and wherein a set of tokens is generated and linked to an alternative asset class, such that the value of a token in the set represents a defined unit of the alternative asset class wherein the set of tokens represent fractional ownership interests of units of the alternative asset class. In embodiments, provided herein is a platform for enabling transactions wherein a set of tokens is generated and linked to an alternative asset class, such that the value of a token in the set represents a defined unit of the alternative asset class, wherein the token is a non-fungible token that represents a specific unit of the alternative asset class and wherein a set of tokens is generated and linked to an alternative asset class, such that the value of a token in the set represents a defined unit of the alternative asset class, wherein the alternative asset class is one or more of a data stream, a revenue stream, an energy stream, a future income stream, a future production capacity, a future intellectual property capacity, and a future or derivative of any of the foregoing. In embodiments, provided herein is a platform for enabling transactions wherein a set of tokens is generated and linked to an alternative asset class, such that the value of a token in the set represents a defined unit of the alternative asset class, wherein the token is a non-fungible token that represents a specific unit of the alternative asset class and wherein a set of tokens is generated and linked to an alternative asset class, such that the value of a token in the set represents a defined unit of the alternative asset class is a blended asset class of at least two assets among a data stream, a revenue stream, an energy stream, a future income stream, a future production capacity, a future intellectual property capacity, and a future or derivative of any of the foregoing. In embodiments, provided herein is a platform for enabling transactions wherein a set of tokens is generated and linked to an alternative asset class, such that the value of a token in the set represents a defined unit of the alternative asset class, wherein the token is a non-fungible token that represents a specific unit of the alternative asset class and wherein a set of tokens is generated and linked to an alternative asset class, such that the value of a token in the set represents a defined unit of the alternative asset class, having a set of interfaces for designing a token that represents a set of alternative assets that are blended by a user of the interface to provide a targeted risk/return profile. In embodiments, provided herein is a platform for enabling transactions wherein a set of tokens is generated and linked to an alternative asset class, such that the value of a token in the set represents a defined unit of the alternative asset class, wherein the token is a non-fungible token that represents a specific unit of the alternative asset class and wherein a set of tokens is generated and linked to an alternative asset class, such that the value of a token in the set represents a defined unit of the alternative asset class, having a digital twin system for representing a set of parameters of the tokens and the alternative assets that back the tokens. In embodiments, provided herein is a platform for enabling transactions wherein a set of tokens is generated and linked to an alternative asset class, such that the value of a token in the set represents a defined unit of the alternative asset class, wherein the token is a non-fungible token that represents a specific unit of the alternative asset class and wherein a set of tokens is generated and linked to an alternative asset class, such that the value of a token in the set represents a defined unit of the alternative asset class, having a data collection system for automatically collecting information about the alternative assets that back the tokens. In embodiments, provided herein is a platform for enabling transactions wherein a set of tokens is generated and linked to an alternative asset class, such that the value of a token in the set represents a defined unit of the alternative asset class, wherein the token is a non-fungible token that represents a specific unit of the alternative asset class and wherein a set of tokens is generated and linked to an alternative asset class, such that the value of a token in the set represents a defined unit of the alternative asset class, having an analytic system for calculating and outputting a set of measures that represent parameters of the alternative assets that back the tokens, wherein the measures represent one or more of a price, a value, a volatility, a risk measure, a trading measure, a future price, an option price, and a derivative price. In embodiments, provided herein is a platform for enabling transactions wherein a set of tokens is generated and linked to an alternative asset class, such that the value of a token in the set represents a defined unit of the alternative asset class, wherein the token is a non-fungible token that represents a specific unit of the alternative asset class and wherein a set of tokens is generated and linked to an alternative asset class, such that the value of a token in the set represents a defined unit of the alternative asset class, having an analytic system for calculating and outputting a set of measures that represent parameters of the tokens, wherein the set of measures includes one or more of a token price, a token value, a token volatility, a token trading velocity, a token future price, a token risk measure, a token derivative price, and a token option price.

In embodiments, provided herein is a platform for enabling transactions wherein a set of tokens is generated and linked to an alternative asset class, such that the value of a token in the set represents a defined unit of the alternative asset class wherein a token is a fungible token that represents an amount of the alternative asset class. In embodiments, provided herein is a platform for enabling transactions wherein a set of tokens is generated and linked to an alternative asset class, such that the value of a token in the set represents a defined unit of the alternative asset class wherein a token is a fungible token that represents an amount of the alternative asset class and wherein a set of tokens is generated and linked to an alternative asset class, such that the value of a token in the set represents a defined unit of the alternative asset class wherein a token represents an indexed value of the alternative asset class. In embodiments, provided herein is a platform for enabling transactions wherein a set of tokens is generated and linked to an alternative asset class, such that the value of a token in the set represents a defined unit of the alternative asset class wherein a token is a fungible token that represents an amount of the alternative asset class and wherein a set of tokens is generated and linked to an alternative asset class, such that the value of a token in the set represents a defined unit of the alternative asset class wherein the set of tokens represent fractional ownership interests of units of the alternative asset class. In embodiments, provided herein is a platform for enabling transactions wherein a set of tokens is generated and linked to an alternative asset class, such that the value of a token in the set represents a defined unit of the alternative asset class wherein a token is a fungible token that represents an amount of the alternative asset class and wherein a set of tokens is generated and linked to an alternative asset class, such that the value of a token in the set represents a defined unit of the alternative asset class, wherein the alternative asset class is one or more of a data stream, a revenue stream, an energy stream, a future income stream, a future production capacity, a future intellectual property capacity, and a future or derivative of any of the foregoing. In embodiments, provided herein is a platform for enabling transactions wherein a set of tokens is generated and linked to an alternative asset class, such that the value of a token in the set represents a defined unit of the alternative asset class wherein a token is a fungible token that represents an amount of the alternative asset class and wherein a set of tokens is generated and linked to an alternative asset class, such that the value of a token in the set represents a defined unit of the alternative asset class is a blended asset class of at least two assets among a data stream, a revenue stream, an energy stream, a future income stream, a future production capacity, a future intellectual property capacity, and a future or derivative of any of the foregoing. In embodiments, provided herein is a platform for enabling transactions wherein a set of tokens is generated and linked to an alternative asset class, such that the value of a token in the set represents a defined unit of the alternative asset class wherein a token is a fungible token that represents an amount of the alternative asset class and wherein a set of tokens is generated and linked to an alternative asset class, such that the value of a token in the set represents a defined unit of the alternative asset class, having a set of interfaces for designing a token that represents a set of alternative assets that are blended by a user of the interface to provide a targeted risk/return profile. In embodiments, provided herein is a platform for enabling transactions wherein a set of tokens is generated and linked to an alternative asset class, such that the value of a token in the set represents a defined unit of the alternative asset class wherein a token is a fungible token that represents an amount of the alternative asset class and wherein a set of tokens is generated and linked to an alternative asset class, such that the value of a token in the set represents a defined unit of the alternative asset class, having a digital twin system for representing a set of parameters of the tokens and the alternative assets that back the tokens. In embodiments, provided herein is a platform for enabling transactions wherein a set of tokens is generated and linked to an alternative asset class, such that the value of a token in the set represents a defined unit of the alternative asset class wherein a token is a fungible token that represents an amount of the alternative asset class and wherein a set of tokens is generated and linked to an alternative asset class, such that the value of a token in the set represents a defined unit of the alternative asset class, having a data collection system for automatically collecting information about the alternative assets that back the tokens. In embodiments, provided herein is a platform for enabling transactions wherein a set of tokens is generated and linked to an alternative asset class, such that the value of a token in the set represents a defined unit of the alternative asset class wherein a token is a fungible token that represents an amount of the alternative asset class and wherein a set of tokens is generated and linked to an alternative asset class, such that the value of a token in the set represents a defined unit of the alternative asset class, having an analytic system for calculating and outputting a set of measures that represent parameters of the alternative assets that back the tokens, wherein the measures represent one or more of a price, a value, a volatility, a risk measure, a trading measure, a future price, an option price, and a derivative price. In embodiments, provided herein is a platform for enabling transactions wherein a set of tokens is generated and linked to an alternative asset class, such that the value of a token in the set represents a defined unit of the alternative asset class wherein a token is a fungible token that represents an amount of the alternative asset class and wherein a set of tokens is generated and linked to an alternative asset class, such that the value of a token in the set represents a defined unit of the alternative asset class, having an analytic system for calculating and outputting a set of measures that represent parameters of the tokens, wherein the set of measures includes one or more of a token price, a token value, a token volatility, a token trading velocity, a token future price, a token risk measure, a token derivative price, and a token option price.

In embodiments, provided herein is a platform for enabling transactions wherein a set of tokens is generated and linked to an alternative asset class, such that the value of a token in the set represents a defined unit of the alternative asset class wherein a token represents an indexed value of the alternative asset class. In embodiments, provided herein is a platform for enabling transactions wherein a set of tokens is generated and linked to an alternative asset class, such that the value of a token in the set represents a defined unit of the alternative asset class wherein a token represents an indexed value of the alternative asset class and wherein a set of tokens is generated and linked to an alternative asset class, such that the value of a token in the set represents a defined unit of the alternative asset class wherein the set of tokens represent fractional ownership interests of units of the alternative asset class. In embodiments, provided herein is a platform for enabling transactions wherein a set of tokens is generated and linked to an alternative asset class, such that the value of a token in the set represents a defined unit of the alternative asset class wherein a token represents an indexed value of the alternative asset class and wherein a set of tokens is generated and linked to an alternative asset class, such that the value of a token in the set represents a defined unit of the alternative asset class, wherein the alternative asset class is one or more of a data stream, a revenue stream, an energy stream, a future income stream, a future production capacity, a future intellectual property capacity, and a future or derivative of any of the foregoing. In embodiments, provided herein is a platform for enabling transactions wherein a set of tokens is generated and linked to an alternative asset class, such that the value of a token in the set represents a defined unit of the alternative asset class wherein a token represents an indexed value of the alternative asset class and wherein a set of tokens is generated and linked to an alternative asset class, such that the value of a token in the set represents a defined unit of the alternative asset class is a blended asset class of at least two assets among a data stream, a revenue stream, an energy stream, a future income stream, a future production capacity, a future intellectual property capacity, and a future or derivative of any of the foregoing. In embodiments, provided herein is a platform for enabling transactions wherein a set of tokens is generated and linked to an alternative asset class, such that the value of a token in the set represents a defined unit of the alternative asset class wherein a token represents an indexed value of the alternative asset class and wherein a set of tokens is generated and linked to an alternative asset class, such that the value of a token in the set represents a defined unit of the alternative asset class, having a set of interfaces for designing a token that represents a set of alternative assets that are blended by a user of the interface to provide a targeted risk/return profile. In embodiments, provided herein is a platform for enabling transactions wherein a set of tokens is generated and linked to an alternative asset class, such that the value of a token in the set represents a defined unit of the alternative asset class wherein a token represents an indexed value of the alternative asset class and wherein a set of tokens is generated and linked to an alternative asset class, such that the value of a token in the set represents a defined unit of the alternative asset class, having a digital twin system for representing a set of parameters of the tokens and the alternative assets that back the tokens. In embodiments, provided herein is a platform for enabling transactions wherein a set of tokens is generated and linked to an alternative asset class, such that the value of a token in the set represents a defined unit of the alternative asset class wherein a token represents an indexed value of the alternative asset class and wherein a set of tokens is generated and linked to an alternative asset class, such that the value of a token in the set represents a defined unit of the alternative asset class, having a data collection system for automatically collecting information about the alternative assets that back the tokens. In embodiments, provided herein is a platform for enabling transactions wherein a set of tokens is generated and linked to an alternative asset class, such that the value of a token in the set represents a defined unit of the alternative asset class wherein a token represents an indexed value of the alternative asset class and wherein a set of tokens is generated and linked to an alternative asset class, such that the value of a token in the set represents a defined unit of the alternative asset class, having an analytic system for calculating and outputting a set of measures that represent parameters of the alternative assets that back the tokens, wherein the measures represent one or more of a price, a value, a volatility, a risk measure, a trading measure, a future price, an option price, and a derivative price. In embodiments, provided herein is a platform for enabling transactions wherein a set of tokens is generated and linked to an alternative asset class, such that the value of a token in the set represents a defined unit of the alternative asset class wherein a token represents an indexed value of the alternative asset class and wherein a set of tokens is generated and linked to an alternative asset class, such that the value of a token in the set represents a defined unit of the alternative asset class, having an analytic system for calculating and outputting a set of measures that represent parameters of the tokens, wherein the set of measures includes one or more of a token price, a token value, a token volatility, a token trading velocity, a token future price, a token risk measure, a token derivative price, and a token option price.

In embodiments, provided herein is a platform for enabling transactions wherein a set of tokens is generated and linked to an alternative asset class, such that the value of a token in the set represents a defined unit of the alternative asset class wherein the set of tokens represent fractional ownership interests of units of the alternative asset class. In embodiments, provided herein is a platform for enabling transactions wherein a set of tokens is generated and linked to an alternative asset class, such that the value of a token in the set represents a defined unit of the alternative asset class wherein the set of tokens represent fractional ownership interests of units of the alternative asset class and wherein a set of tokens is generated and linked to an alternative asset class, such that the value of a token in the set represents a defined unit of the alternative asset class, wherein the alternative asset class is one or more of a data stream, a revenue stream, an energy stream, a future income stream, a future production capacity, a future intellectual property capacity, and a future or derivative of any of the foregoing. In embodiments, provided herein is a platform for enabling transactions wherein a set of tokens is generated and linked to an alternative asset class, such that the value of a token in the set represents a defined unit of the alternative asset class wherein the set of tokens represent fractional ownership interests of units of the alternative asset class and wherein a set of tokens is generated and linked to an alternative asset class, such that the value of a token in the set represents a defined unit of the alternative asset class is a blended asset class of at least two assets among a data stream, a revenue stream, an energy stream, a future income stream, a future production capacity, a future intellectual property capacity, and a future or derivative of any of the foregoing. In embodiments, provided herein is a platform for enabling transactions wherein a set of tokens is generated and linked to an alternative asset class, such that the value of a token in the set represents a defined unit of the alternative asset class wherein the set of tokens represent fractional ownership interests of units of the alternative asset class and wherein a set of tokens is generated and linked to an alternative asset class, such that the value of a token in the set represents a defined unit of the alternative asset class, having a set of interfaces for designing a token that represents a set of alternative assets that are blended by a user of the interface to provide a targeted risk/return profile. In embodiments, provided herein is a platform for enabling transactions wherein a set of tokens is generated and linked to an alternative asset class, such that the value of a token in the set represents a defined unit of the alternative asset class wherein the set of tokens represent fractional ownership interests of units of the alternative asset class and wherein a set of tokens is generated and linked to an alternative asset class, such that the value of a token in the set represents a defined unit of the alternative asset class, having a digital twin system for representing a set of parameters of the tokens and the alternative assets that back the tokens. In embodiments, provided herein is a platform for enabling transactions wherein a set of tokens is generated and linked to an alternative asset class, such that the value of a token in the set represents a defined unit of the alternative asset class wherein the set of tokens represent fractional ownership interests of units of the alternative asset class and wherein a set of tokens is generated and linked to an alternative asset class, such that the value of a token in the set represents a defined unit of the alternative asset class, having a data collection system for automatically collecting information about the alternative assets that back the tokens. In embodiments, provided herein is a platform for enabling transactions wherein a set of tokens is generated and linked to an alternative asset class, such that the value of a token in the set represents a defined unit of the alternative asset class wherein the set of tokens represent fractional ownership interests of units of the alternative asset class and wherein a set of tokens is generated and linked to an alternative asset class, such that the value of a token in the set represents a defined unit of the alternative asset class, having an analytic system for calculating and outputting a set of measures that represent parameters of the alternative assets that back the tokens, wherein the measures represent one or more of a price, a value, a volatility, a risk measure, a trading measure, a future price, an option price, and a derivative price. In embodiments, provided herein is a platform for enabling transactions wherein a set of tokens is generated and linked to an alternative asset class, such that the value of a token in the set represents a defined unit of the alternative asset class wherein the set of tokens represent fractional ownership interests of units of the alternative asset class and wherein a set of tokens is generated and linked to an alternative asset class, such that the value of a token in the set represents a defined unit of the alternative asset class, having an analytic system for calculating and outputting a set of measures that represent parameters of the tokens, wherein the set of measures includes one or more of a token price, a token value, a token volatility, a token trading velocity, a token future price, a token risk measure, a token derivative price, and a token option price.

In embodiments, provided herein is a platform for enabling transactions wherein a set of tokens is generated and linked to an alternative asset class, such that the value of a token in the set represents a defined unit of the alternative asset class, wherein the alternative asset class is one or more of a data stream, a revenue stream, an energy stream, a future income stream, a future production capacity, a future intellectual property capacity, and a future or derivative of any of the foregoing. In embodiments, provided herein is a platform for enabling transactions wherein a set of tokens is generated and linked to an alternative asset class, such that the value of a token in the set represents a defined unit of the alternative asset class, wherein the alternative asset class is one or more of a data stream, a revenue stream, an energy stream, a future income stream, a future production capacity, a future intellectual property capacity, and a future or derivative of any of the foregoing and wherein a set of tokens is generated and linked to an alternative asset class, such that the value of a token in the set represents a defined unit of the alternative asset class is a blended asset class of at least two assets among a data stream, a revenue stream, an energy stream, a future income stream, a future production capacity, a future intellectual property capacity, and a future or derivative of any of the foregoing. In embodiments, provided herein is a platform for enabling transactions wherein a set of tokens is generated and linked to an alternative asset class, such that the value of a token in the set represents a defined unit of the alternative asset class, wherein the alternative asset class is one or more of a data stream, a revenue stream, an energy stream, a future income stream, a future production capacity, a future intellectual property capacity, and a future or derivative of any of the foregoing and wherein a set of tokens is generated and linked to an alternative asset class, such that the value of a token in the set represents a defined unit of the alternative asset class, having a set of interfaces for designing a token that represents a set of alternative assets that are blended by a user of the interface to provide a targeted risk/return profile. In embodiments, provided herein is a platform for enabling transactions wherein a set of tokens is generated and linked to an alternative asset class, such that the value of a token in the set represents a defined unit of the alternative asset class, wherein the alternative asset class is one or more of a data stream, a revenue stream, an energy stream, a future income stream, a future production capacity, a future intellectual property capacity, and a future or derivative of any of the foregoing and wherein a set of tokens is generated and linked to an alternative asset class, such that the value of a token in the set represents a defined unit of the alternative asset class, having a digital twin system for representing a set of parameters of the tokens and the alternative assets that back the tokens. In embodiments, provided herein is a platform for enabling transactions wherein a set of tokens is generated and linked to an alternative asset class, such that the value of a token in the set represents a defined unit of the alternative asset class, wherein the alternative asset class is one or more of a data stream, a revenue stream, an energy stream, a future income stream, a future production capacity, a future intellectual property capacity, and a future or derivative of any of the foregoing and wherein a set of tokens is generated and linked to an alternative asset class, such that the value of a token in the set represents a defined unit of the alternative asset class, having a data collection system for automatically collecting information about the alternative assets that back the tokens. In embodiments, provided herein is a platform for enabling transactions wherein a set of tokens is generated and linked to an alternative asset class, such that the value of a token in the set represents a defined unit of the alternative asset class, wherein the alternative asset class is one or more of a data stream, a revenue stream, an energy stream, a future income stream, a future production capacity, a future intellectual property capacity, and a future or derivative of any of the foregoing and wherein a set of tokens is generated and linked to an alternative asset class, such that the value of a token in the set represents a defined unit of the alternative asset class, having an analytic system for calculating and outputting a set of measures that represent parameters of the alternative assets that back the tokens, wherein the measures represent one or more of a price, a value, a volatility, a risk measure, a trading measure, a future price, an option price, and a derivative price. In embodiments, provided herein is a platform for enabling transactions wherein a set of tokens is generated and linked to an alternative asset class, such that the value of a token in the set represents a defined unit of the alternative asset class, wherein the alternative asset class is one or more of a data stream, a revenue stream, an energy stream, a future income stream, a future production capacity, a future intellectual property capacity, and a future or derivative of any of the foregoing and wherein a set of tokens is generated and linked to an alternative asset class, such that the value of a token in the set represents a defined unit of the alternative asset class, having an analytic system for calculating and outputting a set of measures that represent parameters of the tokens, wherein the set of measures includes one or more of a token price, a token value, a token volatility, a token trading velocity, a token future price, a token risk measure, a token derivative price, and a token option price.

In embodiments, provided herein is a platform for enabling transactions wherein a set of tokens is generated and linked to an alternative asset class, such that the value of a token in the set represents a defined unit of the alternative asset class is a blended asset class of at least two assets among a data stream, a revenue stream, an energy stream, a future income stream, a future production capacity, a future intellectual property capacity, and a future or derivative of any of the foregoing. In embodiments, provided herein is a platform for enabling transactions wherein a set of tokens is generated and linked to an alternative asset class, such that the value of a token in the set represents a defined unit of the alternative asset class is a blended asset class of at least two assets among a data stream, a revenue stream, an energy stream, a future income stream, a future production capacity, a future intellectual property capacity, and a future or derivative of any of the foregoing and wherein a set of tokens is generated and linked to an alternative asset class, such that the value of a token in the set represents a defined unit of the alternative asset class, having a set of interfaces for designing a token that represents a set of alternative assets that are blended by a user of the interface to provide a targeted risk/return profile. In embodiments, provided herein is a platform for enabling transactions wherein a set of tokens is generated and linked to an alternative asset class, such that the value of a token in the set represents a defined unit of the alternative asset class is a blended asset class of at least two assets among a data stream, a revenue stream, an energy stream, a future income stream, a future production capacity, a future intellectual property capacity, and a future or derivative of any of the foregoing and wherein a set of tokens is generated and linked to an alternative asset class, such that the value of a token in the set represents a defined unit of the alternative asset class, having a digital twin system for representing a set of parameters of the tokens and the alternative assets that back the tokens. In embodiments, provided herein is a platform for enabling transactions wherein a set of tokens is generated and linked to an alternative asset class, such that the value of a token in the set represents a defined unit of the alternative asset class is a blended asset class of at least two assets among a data stream, a revenue stream, an energy stream, a future income stream, a future production capacity, a future intellectual property capacity, and a future or derivative of any of the foregoing and wherein a set of tokens is generated and linked to an alternative asset class, such that the value of a token in the set represents a defined unit of the alternative asset class, having a data collection system for automatically collecting information about the alternative assets that back the tokens. In embodiments, provided herein is a platform for enabling transactions wherein a set of tokens is generated and linked to an alternative asset class, such that the value of a token in the set represents a defined unit of the alternative asset class is a blended asset class of at least two assets among a data stream, a revenue stream, an energy stream, a future income stream, a future production capacity, a future intellectual property capacity, and a future or derivative of any of the foregoing and wherein a set of tokens is generated and linked to an alternative asset class, such that the value of a token in the set represents a defined unit of the alternative asset class, having an analytic system for calculating and outputting a set of measures that represent parameters of the alternative assets that back the tokens, wherein the measures represent one or more of a price, a value, a volatility, a risk measure, a trading measure, a future price, an option price, and a derivative price. In embodiments, provided herein is a platform for enabling transactions wherein a set of tokens is generated and linked to an alternative asset class, such that the value of a token in the set represents a defined unit of the alternative asset class is a blended asset class of at least two assets among a data stream, a revenue stream, an energy stream, a future income stream, a future production capacity, a future intellectual property capacity, and a future or derivative of any of the foregoing and wherein a set of tokens is generated and linked to an alternative asset class, such that the value of a token in the set represents a defined unit of the alternative asset class, having an analytic system for calculating and outputting a set of measures that represent parameters of the tokens, wherein the set of measures includes one or more of a token price, a token value, a token volatility, a token trading velocity, a token future price, a token risk measure, a token derivative price, and a token option price.

In embodiments, provided herein is a platform for enabling transactions wherein a set of tokens is generated and linked to an alternative asset class, such that the value of a token in the set represents a defined unit of the alternative asset class, having a set of interfaces for designing a token that represents a set of alternative assets that are blended by a user of the interface to provide a targeted risk/return profile. In embodiments, provided herein is a platform for enabling transactions wherein a set of tokens is generated and linked to an alternative asset class, such that the value of a token in the set represents a defined unit of the alternative asset class, having a set of interfaces for designing a token that represents a set of alternative assets that are blended by a user of the interface to provide a targeted risk/return profile and wherein a set of tokens is generated and linked to an alternative asset class, such that the value of a token in the set represents a defined unit of the alternative asset class, having a digital twin system for representing a set of parameters of the tokens and the alternative assets that back the tokens. In embodiments, provided herein is a platform for enabling transactions wherein a set of tokens is generated and linked to an alternative asset class, such that the value of a token in the set represents a defined unit of the alternative asset class, having a set of interfaces for designing a token that represents a set of alternative assets that are blended by a user of the interface to provide a targeted risk/return profile and wherein a set of tokens is generated and linked to an alternative asset class, such that the value of a token in the set represents a defined unit of the alternative asset class, having a data collection system for automatically collecting information about the alternative assets that back the tokens. In embodiments, provided herein is a platform for enabling transactions wherein a set of tokens is generated and linked to an alternative asset class, such that the value of a token in the set represents a defined unit of the alternative asset class, having a set of interfaces for designing a token that represents a set of alternative assets that are blended by a user of the interface to provide a targeted risk/return profile and wherein a set of tokens is generated and linked to an alternative asset class, such that the value of a token in the set represents a defined unit of the alternative asset class, having an analytic system for calculating and outputting a set of measures that represent parameters of the alternative assets that back the tokens, wherein the measures represent one or more of a price, a value, a volatility, a risk measure, a trading measure, a future price, an option price, and a derivative price. In embodiments, provided herein is a platform for enabling transactions wherein a set of tokens is generated and linked to an alternative asset class, such that the value of a token in the set represents a defined unit of the alternative asset class, having a set of interfaces for designing a token that represents a set of alternative assets that are blended by a user of the interface to provide a targeted risk/return profile and wherein a set of tokens is generated and linked to an alternative asset class, such that the value of a token in the set represents a defined unit of the alternative asset class, having an analytic system for calculating and outputting a set of measures that represent parameters of the tokens, wherein the set of measures includes one or more of a token price, a token value, a token volatility, a token trading velocity, a token future price, a token risk measure, a token derivative price, and a token option price.

In embodiments, provided herein is a platform for enabling transactions wherein a set of tokens is generated and linked to an alternative asset class, such that the value of a token in the set represents a defined unit of the alternative asset class, having a digital twin system for representing a set of parameters of the tokens and the alternative assets that back the tokens. In embodiments, provided herein is a platform for enabling transactions wherein a set of tokens is generated and linked to an alternative asset class, such that the value of a token in the set represents a defined unit of the alternative asset class, having a digital twin system for representing a set of parameters of the tokens and the alternative assets that back the tokens and wherein a set of tokens is generated and linked to an alternative asset class, such that the value of a token in the set represents a defined unit of the alternative asset class, having a data collection system for automatically collecting information about the alternative assets that back the tokens. In embodiments, provided herein is a platform for enabling transactions wherein a set of tokens is generated and linked to an alternative asset class, such that the value of a token in the set represents a defined unit of the alternative asset class, having a digital twin system for representing a set of parameters of the tokens and the alternative assets that back the tokens and wherein a set of tokens is generated and linked to an alternative asset class, such that the value of a token in the set represents a defined unit of the alternative asset class, having an analytic system for calculating and outputting a set of measures that represent parameters of the alternative assets that back the tokens, wherein the measures represent one or more of a price, a value, a volatility, a risk measure, a trading measure, a future price, an option price, and a derivative price. In embodiments, provided herein is a platform for enabling transactions wherein a set of tokens is generated and linked to an alternative asset class, such that the value of a token in the set represents a defined unit of the alternative asset class, having a digital twin system for representing a set of parameters of the tokens and the alternative assets that back the tokens and wherein a set of tokens is generated and linked to an alternative asset class, such that the value of a token in the set represents a defined unit of the alternative asset class, having an analytic system for calculating and outputting a set of measures that represent parameters of the tokens, wherein the set of measures includes one or more of a token price, a token value, a token volatility, a token trading velocity, a token future price, a token risk measure, a token derivative price, and a token option price.

In embodiments, provided herein is a platform for enabling transactions wherein a set of tokens is generated and linked to an alternative asset class, such that the value of a token in the set represents a defined unit of the alternative asset class, having a data collection system for automatically collecting information about the alternative assets that back the tokens. In embodiments, provided herein is a platform for enabling transactions wherein a set of tokens is generated and linked to an alternative asset class, such that the value of a token in the set represents a defined unit of the alternative asset class, having a data collection system for automatically collecting information about the alternative assets that back the tokens and wherein a set of tokens is generated and linked to an alternative asset class, such that the value of a token in the set represents a defined unit of the alternative asset class, having an analytic system for calculating and outputting a set of measures that represent parameters of the alternative assets that back the tokens, wherein the measures represent one or more of a price, a value, a volatility, a risk measure, a trading measure, a future price, an option price, and a derivative price. In embodiments, provided herein is a platform for enabling transactions wherein a set of tokens is generated and linked to an alternative asset class, such that the value of a token in the set represents a defined unit of the alternative asset class, having a data collection system for automatically collecting information about the alternative assets that back the tokens and wherein a set of tokens is generated and linked to an alternative asset class, such that the value of a token in the set represents a defined unit of the alternative asset class, having an analytic system for calculating and outputting a set of measures that represent parameters of the tokens, wherein the set of measures includes one or more of a token price, a token value, a token volatility, a token trading velocity, a token future price, a token risk measure, a token derivative price, and a token option price.

In embodiments, provided herein is a platform for enabling transactions wherein a set of tokens is generated and linked to an alternative asset class, such that the value of a token in the set represents a defined unit of the alternative asset class, having an analytic system for calculating and outputting a set of measures that represent parameters of the alternative assets that back the tokens, wherein the measures represent one or more of a price, a value, a volatility, a risk measure, a trading measure, a future price, an option price, and a derivative price. In embodiments, provided herein is a platform for enabling transactions wherein a set of tokens is generated and linked to an alternative asset class, such that the value of a token in the set represents a defined unit of the alternative asset class, having an analytic system for calculating and outputting a set of measures that represent parameters of the alternative assets that back the tokens, wherein the measures represent one or more of a price, a value, a volatility, a risk measure, a trading measure, a future price, an option price, and a derivative price and wherein a set of tokens is generated and linked to an alternative asset class, such that the value of a token in the set represents a defined unit of the alternative asset class, having an analytic system for calculating and outputting a set of measures that represent parameters of the tokens, wherein the set of measures includes one or more of a token price, a token value, a token volatility, a token trading velocity, a token future price, a token risk measure, a token derivative price, and a token option price.

In embodiments, provided herein is a platform for enabling transactions wherein a set of tokens is generated and linked to an alternative asset class, such that the value of a token in the set represents a defined unit of the alternative asset class, having an analytic system for calculating and outputting a set of measures that represent parameters of the tokens, wherein the set of measures includes one or more of a token price, a token value, a token volatility, a token trading velocity, a token future price, a token risk measure, a token derivative price, and a token option price.

The background description is presented simply for context, and is not necessarily well-understood, routine, or conventional. Further, the background description is not an admission of what does or does not qualify as prior art. In fact, some or all of the background description may be work attributable to the named inventors that is otherwise unknown in the art.

Certain operations described herein include interpreting, receiving, and/or determining one or more values, parameters, inputs, data, or other information (“receiving data”). Operations to receive data include, without limitation: receiving data via a user input; receiving data over a network of any type; reading a data value from a memory location in communication with the receiving device; utilizing a default value as a received data value; estimating, calculating, or deriving a data value based on other information available to the receiving device; and/or updating any of these in response to a later received data value. In certain embodiments, a data value may be received by a first operation, and later updated by a second operation, as part of the receiving a data value. For example, when communications are down, intermittent, or interrupted, a first receiving operation may be performed, and when communications are restored an updated receiving operation may be performed.

Certain logical groupings of operations herein, for example methods or procedures of the current disclosure, are provided to illustrate aspects of the present disclosure. Operations described herein are schematically described and/or depicted, and operations may be combined, divided, re-ordered, added, or removed in a manner consistent with the disclosure herein. It is understood that the context of an operational description may require an ordering for one or more operations, and/or an order for one or more operations may be explicitly disclosed, but the order of operations should be understood broadly, where any equivalent grouping of operations to provide an equivalent outcome of operations is specifically contemplated herein. For example, if a value is used in one operational step, the determining of the value may be required before that operational step in certain contexts (e.g., where the time delay of data for an operation to achieve a certain effect is important), but may not be required before that operation step in other contexts (e.g. where usage of the value from a previous execution cycle of the operations would be sufficient for those purposes). Accordingly, in certain embodiments an order of operations and grouping of operations as described is explicitly contemplated herein, and in certain embodiments re-ordering, subdivision, and/or different grouping of operations is explicitly contemplated herein.

Physical (such as spatial and/or electrical) and functional relationships between elements (for example, between modules, circuit elements, semiconductor layers, etc.) are described using various terms. Unless explicitly described as being “direct,” when a relationship between first and second elements is described, that relationship encompasses both (i) a direct relationship where no other intervening elements are present between the first and second elements and (ii) an indirect relationship where one or more intervening elements are present between the first and second elements.

Example relationship terms include “adjoining,” “transmitting,” “receiving,” “connected,” “engaged,” “coupled,” “adjacent,” “next to,” “on top of,” “above,” “below,” “abutting,” and “disposed.”

The detailed description includes specific examples for illustration only, and not to limit the disclosure or its applicability. The examples are not intended to be an exhaustive list, but instead simply demonstrate possession by the inventors of the full scope of the currently presented and envisioned future claims. Variations, combinations, and equivalents of the examples are within the scope of the disclosure.

No language in the specification should be construed as indicating that any non-claimed element is essential or critical to the practice of the disclosure.

The term “exemplary” simply means “example” and does not indicate a best or preferred example.

The term “set” does not necessarily exclude the empty set—in other words, in some circumstances a “set” may have zero elements. The term “non-empty set” may be used to indicate exclusion of the empty set—that is, a non-empty set must have one or more elements.

The term “subset” does not necessarily require a proper subset. In other words, a “subset” of a first set may be coextensive with (equal to) the first set. Further, the term “subset” does not necessarily exclude the empty set—in some circumstances a “subset” may have zero elements.

The phrase “at least one of A, B, and C” should be construed to mean a logical (A OR B OR C), using a non-exclusive logical OR, and should not be construed to mean “at least one of A, at least one of B, and at least one of C.”

The use of the terms “a,” “an,” “the,” and similar referents in the context of describing the disclosure and claims encompasses both the singular and the plural, unless contradicted explicitly or by context.

Unless otherwise specified, the terms “comprising,” “having,” “with,” “including,” and “containing,” and their variants, are open-ended terms, meaning “including, but not limited to.”

Each publication referenced in this disclosure, including foreign and domestic patent applications and patents, is hereby incorporated by reference in its entirety.

Although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of multiple embodiments remain within the scope of this disclosure.

One or more elements (for example, steps within a method, instructions, actions, or operations) may be executed in a different order (and/or concurrently) without altering the principles of the present disclosure.

Unless technically infeasible, elements described as being in series may be implemented partially or fully in parallel. Similarly, unless technically infeasible, elements described as being in parallel may be implemented partially or fully in series.

While the disclosure describes structures corresponding to claimed elements, those elements do not necessarily invoke a means plus function interpretation unless they explicitly use the signifier “means for.”

While the drawings divide elements of the disclosure into different functional blocks or action blocks, these divisions are for illustration only. According to the principles of the present disclosure, functionality can be combined in other ways such that some or all functionality from multiple separately-depicted blocks can be implemented in a single functional block; similarly, functionality depicted in a single block may be separated into multiple blocks.

Unless explicitly stated as mutually exclusive, features depicted in different drawings can be combined consistent with the principles of the present disclosure.

In the drawings, reference numbers may be reused to identify identical elements or may simply identify elements that implement similar functionality.

Numbering or other labeling of instructions or method steps is done for convenient reference, not to indicate a fixed order.

In the drawings, the direction of an arrow, as indicated by the arrowhead, generally demonstrates the flow of information (such as data or instructions) that is of interest to the illustration. For example, when element A and element B exchange a variety of information, but information transmitted from element A to element B is relevant to the illustration, the arrow may point from element A to element B. This unidirectional arrow does not imply that no other information is transmitted from element B to element A. As just one example, for information sent from element A to element B, element B may send requests and/or acknowledgements to element A.

Unless otherwise indicated, recitations of ranges of values are merely intended to serve as a shorthand way of referring individually to each separate value falling within the range, and each separate value is hereby incorporated into the specification as if it were individually recited.

### Special-Purpose System

A special-purpose system includes hardware and/or software and may be described in terms of an apparatus, a method, or a computer-readable medium. In various embodiments, functionality may be apportioned differently between software and hardware. For example, some functionality may be implemented by hardware in one embodiment and by software in another embodiment. Further, software may be encoded by hardware structures, and hardware may be defined by software, such as in software-defined networking or software-defined radio.

In this application, including the claims, the term module refers to a special-purpose system. The module may be implemented by one or more special-purpose systems. The one or more special-purpose systems may also implement some or all of the other modules.

In this application, including the claims, the term module may be replaced with the terms controller or circuit.

In this application, including the claims, the term platform refers to one or more modules that offer a set of functions.

In this application, including the claims, the term system may be used interchangeably with module or with the term special-purpose system.

The special-purpose system may be directed or controlled by an operator. The special-purpose system may be hosted by one or more of assets owned by the operator, assets leased by the operator, and third-party assets. The assets may be referred to as a private, community, or hybrid cloud computing network or cloud computing environment.

For example, the special-purpose system may be partially or fully hosted by a third party offering software as a service (SaaS), platform as a service (PaaS), and/or infrastructure as a service (IaaS).

The special-purpose system may be implemented using agile development and operations (DevOps) principles. In embodiments, some or all of the special-purpose system may be implemented in a multiple-environment architecture. For example, the multiple environments may include one or more production environments, one or more integration environments, one or more development environments, etc.

### Device Examples

A special-purpose system may be partially or fully implemented using or by a mobile device. Examples of mobile devices include navigation devices, cell phones, smart phones, mobile phones, mobile personal digital assistants, palmtops, netbooks, pagers, electronic book readers, tablets, music players, etc.

A special-purpose system may be partially or fully implemented using or by a network device. Examples of network devices include switches, routers, firewalls, gateways, hubs, base stations, access points, repeaters, head-ends, user equipment, cell sites, antennas, towers, etc.

A special-purpose system may be partially or fully implemented using a computer having a variety of form factors and other characteristics. For example, the computer may be characterized as a personal computer, as a server, etc. The computer may be portable, as in the case of a laptop, netbook, etc. The computer may or may not have any output device, such as a monitor, line printer, liquid crystal display (LCD), light emitting diodes (LEDs), etc. The computer may or may not have any input device, such as a keyboard, mouse, touchpad, trackpad, computer vision system, barcode scanner, button array, etc. The computer may run a general-purpose operating system, such as the WINDOWS operating system from Microsoft Corporation, the MACOS operating system from Apple, Inc., or a variant of the LINUX operating system.

Examples of servers include a file server, print server, domain server, internet server, intranet server, cloud server, infrastructure-as-a-service server, platform-as-a-service server, web server, secondary server, host server, distributed server, failover server, and backup server.

### Hardware

The term hardware encompasses components such as processing hardware, storage hardware, networking hardware, and other general-purpose and special-purpose components. Note that these are not mutually-exclusive categories. For example, processing hardware may integrate storage hardware and vice versa.

Examples of a component are integrated circuits (ICs), application specific integrated circuit (ASICs), digital circuit elements, analog circuit elements, combinational logic circuits, gate arrays such as field programmable gate arrays (FPGAs), digital signal processors (DSPs), complex programmable logic devices (CPLDs), etc.

Multiple components of the hardware may be integrated, such as on a single die, in a single package, or on a single printed circuit board or logic board. For example, multiple components of the hardware may be implemented as a system-on-chip. A component, or a set of integrated components, may be referred to as a chip, chipset, chiplet, or chip stack.

Examples of a system-on-chip include a radio frequency (RF) system-on-chip, an artificial intelligence (AI) system-on-chip, a video processing system-on-chip, an organ-on-chip, a quantum algorithm system-on-chip, etc.

The hardware may integrate and/or receive signals from sensors. The sensors may allow observation and measurement of conditions including temperature, pressure, wear, light, humidity, deformation, expansion, contraction, deflection, bending, stress, strain, load-bearing, shrinkage, power, energy, mass, location, temperature, humidity, pressure, viscosity, liquid flow, chemical/gas presence, sound, and air quality. A sensor may include image and/or video capture in visible and/or non-visible (such as thermal) wavelengths, such as a charge-coupled device (CCD) or complementary metal-oxide semiconductor (CMOS) sensor.

### Processing Hardware

Examples of processing hardware include a central processing unit (CPU), a graphics processing unit (GPU), an approximate computing processor, a quantum computing processor, a parallel computing processor, a neural network processor, a signal processor, a digital processor, a data processor, an embedded processor, a microprocessor, and a co-processor. The co-processor may provide additional processing functions and/or optimizations, such as for speed or power consumption. Examples of a co-processor include a math co-processor, a graphics co-processor, a communication co-processor, a video co-processor, and an artificial intelligence (AI) co-processor.

### Processor Architecture

The processor may enable execution of multiple threads. These multiple threads may correspond to different programs. In various embodiments, a single program may be implemented as multiple threads by the programmer or may be decomposed into multiple threads by the processing hardware. The threads may be executed simultaneously to enhance the performance of the processor and to facilitate simultaneous operations of the application.

A processor may be implemented as a packaged semiconductor die. The die includes one or more processing cores and may include additional functional blocks, such as cache. In various embodiments, the processor may be implemented by multiple dies, which may be combined in a single package or packaged separately.

### Networking Hardware

The networking hardware may include one or more interface circuits. In some examples, the interface circuit(s) may implement wired or wireless interfaces that connect, directly or indirectly, to one or more networks. Examples of networks include a cellular network, a local area network (LAN), a wireless personal area network (WPAN), a metropolitan area network (MAN), and/or a wide area network (WAN). The networks may include one or more of point-to-point and mesh technologies. Data transmitted or received by the networking components may traverse the same or different networks. Networks may be connected to each other over a WAN or point-to-point leased lines using technologies such as Multiprotocol Label Switching (MPLS) and virtual private networks (VPNs).

Examples of cellular networks include GSM, GPRS, 3G, 4G, 5G, LTE, and EVDO. The cellular network may be implemented using frequency division multiple access (FDMA) network or code division multiple access (CDMA) network.

Examples of a LAN are Institute of Electrical and Electronics Engineers (IEEE) Standard 802.11-2020 (also known as the WIFI wireless networking standard) and IEEE Standard 802.3-2018 (also known as the ETHERNET wired networking standard).

Examples of a WPAN include IEEE Standard 802.15.4, including the ZIGBEE standard from the ZigBee Alliance. Further examples of a WPAN include the BLUETOOTH wireless networking standard, including Core Specification versions 3.0, 4.0, 4.1, 4.2, 5.0, and 5.1 from the Bluetooth Special Interest Group (SIG).

A WAN may also be referred to as a distributed communications system (DCS). One example of a WAN is the internet.

### Storage Hardware

Storage hardware is or includes a computer-readable medium. The term computer-readable medium, as used in this disclosure, encompasses both nonvolatile storage and volatile storage, such as dynamic random access memory (DRAM). The term computer-readable medium only excludes transitory electrical or electromagnetic signals propagating through a medium (such as on a carrier wave). A computer-readable medium in this disclosure is therefore non-transitory, and may also be considered to be tangible.

### Examples

Examples of storage implemented by the storage hardware include a database (such as a relational database or a NoSQL database), a data store, a data lake, a column store, a data warehouse.

Example of storage hardware include nonvolatile memory devices, volatile memory devices, magnetic storage media, a storage area network (SAN), network-attached storage (NAS), optical storage media, printed media (such as bar codes and magnetic ink), and paper media (such as punch cards and paper tape). The storage hardware may include cache memory, which may be collocated with or integrated with processing hardware.

Storage hardware may have read-only, write-once, or read/write properties. Storage hardware may be random access or sequential access. Storage hardware may be location-addressable, file-addressable, and/or content-addressable.

Example of nonvolatile memory devices include flash memory (including NAND and NOR technologies), solid state drives (SSDs), an erasable programmable read-only memory device such as an electrically erasable programmable read-only memory (EEPROM) device, and a mask read-only memory device (ROM).

Example of volatile memory devices include processor registers and random access memory (RAM), such as static RAM (SRAM), dynamic RAM (DRAM), synchronous DRAM (SDRAM), synchronous graphics RAM (SGRAM), and video RAM (VRAM).

Example of magnetic storage media include analog magnetic tape, digital magnetic tape, and rotating hard disk drive (HDDs).

Examples of optical storage media include a CD (such as a CD-R, CD-RW, or CD-ROM), a DVD, a Blu-ray disc, and an Ultra HD Blu-ray disc.

Examples of storage implemented by the storage hardware include a distributed ledger, such as a permissioned or permissionless blockchain.

Entities recording transactions, such as in a blockchain, may reach consensus using an algorithm such as proof-of-stake, proof-of-work, and proof-of-storage.

Elements of the present disclosure may be represented by or encoded as non-fungible tokens (NFTs). Ownership rights related to the non-fungible tokens may be recorded in or referenced by a distributed ledger.

Transactions initiated by or relevant to the present disclosure may use one or both of fiat currency and cryptocurrencies, examples of which include bitcoin and ether.

Some or all features of hardware may be defined using a language for hardware description, such as IEEE Standard 1364-2005 (commonly called “Verilog”) and IEEE Standard 1076-2008 (commonly called “VHDL”). The hardware description language may be used to manufacture and/or program hardware.

A special-purpose system may be distributed across multiple different software and hardware entities. Communication within a special-purpose system and between special-purpose systems may be performed using networking hardware. The distribution may vary across embodiments and may vary over time. For example, the distribution may vary based on demand, with additional hardware and/or software entities invoked to handle higher demand. In various embodiments, a load balancer may direct requests to one of multiple instantiations of the special purpose system. The hardware and/or software entities may be physically distinct and/or may share some hardware and/or software, such as in a virtualized environment. Multiple hardware entities may be referred to as a server rack, server farm, data center, etc.

### Software

Software includes instructions that are machine-readable and/or executable. Instructions may be logically grouped into programs, codes, methods, steps, actions, routines, functions, libraries, objects, classes, etc. Software may be stored by storage hardware or encoded in other hardware. Software encompasses (i) descriptive text to be parsed, such as HTML (hypertext markup language), XML (extensible markup language), and JSON (JavaScript Object Notation), (ii) assembly code, (iii) object code generated from source code by a compiler, (iv) source code for execution by an interpreter, (v) bytecode, (vi) source code for compilation and execution by a just-in-time compiler, etc. As examples only, source code may be written using syntax from languages including C, C++, JavaScript, Java, Python, R, etc.

Software also includes data. However, data and instructions are not mutually-exclusive categories. In various embodiments, the instructions may be used as data in one or more operations. As another example, instructions may be derived from data.

The functional blocks and flowchart elements in this disclosure serve as software specifications, which can be translated into software by the routine work of a skilled technician or programmer.

Software may include and/or rely on firmware, processor microcode, an operating system (OS), a basic input/output system (BIOS), application programming interfaces (APIs), libraries such as dynamic-link libraries (DLLs), device drivers, hypervisors, user applications, background services, background applications, etc. Software includes native applications and web applications. For example, a web application may be served to a device through a browser using hypertext markup language 5th revision (HTML5).

Software may include artificial intelligence systems, which may include machine learning or other computational intelligence. For example, artificial intelligence may include one or more models used for one or more problem domains.

When presented with many data features, identification of a subset of features that are relevant to a problem domain may improve prediction accuracy, reduce storage space, and increase processing speed. This identification may be referred to as feature engineering. Feature engineering may be performed by users or may only be guided by users. In various implementations, a machine learning system may computationally identify relevant features, such as by performing singular value decomposition on the contributions of different features to outputs.

Examples of the models include recurrent neural networks (RNNs) such as long short-term memory (LSTM), deep learning models such as transformers, decision trees, support-vector machines, genetic algorithms, Bayesian networks, and regression analysis. Examples of systems based on a transformer model include bidirectional encoder representations from transformers (BERT) and generative pre-trained transformer (GPT).

Training a machine-learning model may include supervised learning (for example, based on labelled input data), unsupervised learning, and reinforcement learning. In various embodiments, a machine-learning model may be pre-trained by their operator or by a third party.

Problem domains include nearly any situation where structured data can be collected, and includes natural language processing (NLP), computer vision (CV), classification, image recognition, etc.

### Architectures

Some or all of the software may run in a virtual environment rather than directly on hardware. The virtual environment may include a hypervisor, emulator, sandbox, container engine, etc. The software may be built as a virtual machine, a container, etc. Virtualized resources may be controlled using, for example, a DOCKER container platform, a pivotal cloud foundry (PCF) platform, etc.

In a client-server model, some of the software executes on first hardware identified functionally as a server, while other of the software executes on second hardware identified functionally as a client. The identity of the client and server is not fixed: for some functionality, the first hardware may act as the server while for other functionality, the first hardware may act as the client. In different embodiments and in different scenarios, functionality may be shifted between the client and the server. In one dynamic example, some functionality normally performed by the second hardware is shifted to the first hardware when the second hardware has less capability. In various embodiments, the term “local” may be used in place of “client,” and the term “remote” may be used in place of “server.”

Some or all of the software may be logically partitioned into microservices. Each microservice offers a reduced subset of functionality. In various embodiments, each microservice may be scaled independently depending on load, either by devoting more resources to the microservice or by instantiating more instances of the microservice. In various embodiments, functionality offered by one or more microservices may be combined with each other and/or with other software not adhering to a microservices model.

Some or all of the software may be arranged logically into layers. In a layered architecture, a second layer may be logically placed between a first layer and a third layer. The first layer and the third layer would then generally interact with the second layer and not with each other. In various embodiments, this is not strictly enforced—that is, some direct communication may occur between the first and third layers.

1. A method comprising:
implementing a tokenization user interface;
interpreting a token description in response to user operations with the tokenization user interface;
interpreting an asset class description in response to user operations with the tokenization user interface;
interpreting a token link description indicating a token performance wherein the token performance is based on at least one beneficial characteristic of at least one asset of an asset class corresponding to the asset class description, and the at least one beneficial characteristic indicates at least one feature of the at least one asset, other than a present and/or future market value of the at least one asset, that increases the token performance;
generating at least one asset class linked token in response to the token link description and the asset class description; and
exposing the at least one asset class linked token to a token marketplace system.

2. The method of claim 1, further comprising:
interpreting a governance scheme associated with the asset class description; and
generating the at least one asset class linked token further in response to the governance scheme.

3. The method of claim 1, wherein the asset class description comprises at least one of:
a fungible asset class description;
a non-fungible asset class description;
a value stream associated with an asset class corresponding to the asset class description;
a value change description associated with an asset class corresponding to the asset class description; or
a value class characterization associated with an asset class corresponding to the asset class description.

4. The method of claim 1, wherein the asset class description comprises a description corresponding to at least one of:
a precious metal asset class;
an asset pre-cursor;
a fiat currency asset class;
a real estate asset class;
a financial asset class;
a security asset class;
an intellectual property asset class;
a production asset class;
a beneficiary asset of at least one of the foregoing;
a derivative asset of at least one of the foregoing; or
a combined asset of at least two of the foregoing.

5. The method of claim 1, wherein the at least one beneficial characteristic of the at least one asset comprises at least one of:
a risk profile of the at least one asset;
a risk profile of the asset class;
a volatility of the at least one asset;
a volatility of the asset class;
a liquidity of the at least one asset or a liquidity of the asset class.

6. The method of claim 1,
wherein interpreting the token description further comprises a token performance characteristic, wherein the token performance characteristic is based on the at least one beneficial characteristic of the at least one asset class linked token; and
wherein generating the at least one asset class linked token is further in response to the token performance characteristic.

7. The method of claim 6, wherein the token performance characteristic further comprises at least one of:
a token value;
a token estimated future value;
a token volatility;
a token risk profile; or
a token index description.

8. The method of claim 1, wherein the token performance comprises at least one linking rule, the method further comprising adjusting the at least one asset class linked token in response to the at least one linking rule.

9. An apparatus, comprising:
a tokenization controller configured to implement a tokenization user interface, the tokenization controller comprising:
a token definition circuit structured to interpret a token description in response to user operations with the tokenization user interface;
an asset definition circuit structured to interpret an asset class description in response to user operations with the tokenization user interface;
an asset backing circuit structured to,
interpret a token link description indicating a token performance, wherein the token performance is based on at least one beneficial characteristic of at least one asset of an asset class corresponding to the asset class description, and the at least one beneficial characteristic indicates at least one feature of the at least one asset, other than a present and/or future market value of the at least one asset, that increases the token performance, and
generate at least one asset class linked token in response to the token link description and the asset class description; and
a token deployment circuit structured to expose the at least one asset class linked token to a token marketplace system.

10. The apparatus of claim 9,
wherein the asset definition circuit is further structured to interpret a governance scheme associated with the asset class description; and
wherein the asset backing circuit is further structured to generate the at least one asset class linked token further in response to the governance scheme.

11. The apparatus of claim 9, wherein the asset class description comprises at least one of:
a fungible asset class description;
a non-fungible asset class description;
a value stream associated with an asset class corresponding to the asset class description;
a value change description associated with an asset class corresponding to the asset class description; or
a value class characterization associated with an asset class corresponding to the asset class description.

12. The apparatus of claim 9, wherein the asset class description comprises a description corresponding to at least one of:
a precious metal asset class;
an asset pre-cursor;
a fiat currency;
a real estate asset class;
a financial asset class;
a security asset class;
an intellectual property asset class;
a production asset class;
a farming asset class;
a beneficiary asset of at least one of the foregoing;
a derivative asset of at least one of the foregoing; or
a combined asset of at least two of the foregoing.

13. The apparatus of claim 9, wherein the at least one beneficial characteristic of the at least one asset comprises at least one of:
a risk profile of the at least one asset;
a risk profile of the asset class;
a volatility of the at least one asset;
a volatility of the asset class;
a liquidity of the at least one asset; or
a liquidity of the asset class.

14. The apparatus of claim 9,
wherein the token description further comprises a token performance characteristic, the token performance characteristic being based on the at least one beneficial characteristic of the at least one asset class linked token;
and wherein the asset backing circuit is further structured to generate at least one asset class linked token in response to the token performance characteristic.

15. The apparatus of claim 14, wherein the token performance characteristic further comprises at least one of:
a token value;
a token estimated future value;
a token risk profile; or
a token index description.

16. The apparatus of claim 9, further comprising:
wherein the token link description comprises at least one linking rule; and
wherein the token deployment circuit is further structured to adjust the at least one asset class linked token in response to the at least one linking rule.

17. A system, comprising:
a tokenization controller configured to implement a tokenization user interface, the tokenization controller comprising:
a token definition circuit structured to interpret a token description in response to user operations with the tokenization user interface;
an asset definition circuit structured to interpret an asset class description in response to user operations with the tokenization user interface;
an asset backing circuit structured to,
interpret a token link description indicating a token performance, wherein the token performance is based on at least one beneficial characteristic of at least one asset of an asset class corresponding to the asset class description, and the at least one beneficial characteristic indicates at least one feature of the at least one asset, other than a present and/or future market value of the at least one asset, that increases the token performance, and
generate at least one asset class linked token in response to the token link description and the asset class description; and
a token deployment circuit structured to expose the at least one asset class linked token to a token marketplace system; and
a token deployment controller configured to implement an asset class backed token transactions, the token deployment controller comprising:
a token offering component configured to publish the at least one asset class linked token to the token marketplace system;
a token contract component configured to execute a smart contract to acquire the at least one asset class linked token; and
a token recording component configured to record transactions of the at least one asset class linked token in response to execution of the smart contract.

18. The system of claim 17, further comprising:
a token marketplace controller configured to implement an asset class backed token trading system, the token marketplace controller comprising:
a trading system component configured to make the at least one asset class linked token available to at least a portion of users of the asset class backed token trading system, and to accept user inputs for transactions of the at least one asset class linked token.

19. The system of claim 18, wherein the token marketplace controller further comprises a governance system component configured to perform at least one of: adjusting the token link description in response to a governance scheme associated with the asset class description, or confirming the token link description in response to the governance scheme associated with the asset class description.

20. The system of claim 18, wherein the token recording component is further configured to record transactions of the at least one asset class linked token on a blockchain.

21. The system of claim 18, wherein the at least one beneficial characteristic of the at least one asset comprises at least one of:
a risk profile of the at least one asset;
a risk profile of the asset class;
a volatility of the at least one asset;
a volatility of the asset class;
a liquidity of the at least one asset; or
a liquidity of the asset class.

22. The method of claim 1, wherein,
the token performance is based on,
a beneficial characteristic of a first at least one asset that increases a first feature of the token performance, and
a beneficial characteristic of a second at least one asset that increases a second feature of the token performance,
the beneficial characteristic of the first at least one asset is different than the beneficial characteristic of the second at least one asset, and
the first feature of the token performance that is increased by the beneficial characteristic of the first at least one asset is different than the second feature of the token performance that is increased by the beneficial characteristic of the second at least one asset.

23. The method of claim 1, wherein,
a feature of a first at least one asset causes a decrease of a feature of the token performance, and
a beneficial characteristic of a second at least one asset indicates at least one feature of the second at least one asset that increases the feature of the token performance and at least partially offsets the decrease of the feature of the token performance by the first at least one asset.

24. The method of claim 1, wherein generating the at least one asset class linked token further comprises:
receiving the asset class description via user operations with the tokenization user interface, and
populating the at least one asset class linked token with at least one recommended asset based on the asset class description, wherein the at least one recommended asset is based on the at least one beneficial characteristic indicating at least one feature of the at least one asset that increases the token performance of the at least one asset class linked token.

25. The method of claim 1, further comprising: displaying, via the tokenization user interface, a token performance description of the at least one asset class linked token, wherein the token performance description includes a beneficial characteristic description of the at least one feature of the at least one asset, other than a present and/or future market value of the at least one asset, that increases the token performance of the at least one asset class linked token.

26. The method of claim 1, wherein generating the at least one asset class linked token further comprises:
receiving, via user operations with the tokenization user interface, the at least one beneficial characteristic of the at least one asset of the asset class, and
populating the at least one asset class linked token with at least one recommended asset based on the asset class description, wherein the at least one recommended asset is based on at least one feature of the at least one recommended asset that increases the token performance of the at least one asset class linked token in accordance with the at least one beneficial characteristic received via the user operations with the tokenization user interface.

27. The method of claim 1, wherein generating the at least one asset class linked token further comprises:
receiving, via user operations with the tokenization user interface, an asset description of at least one asset to be linked to the at least one asset class linked token,
determining the at least one asset that corresponds to the asset description,
determining the at least one beneficial characteristic based on at least one feature of the at least one asset, and
determining the token performance based on the at least one beneficial characteristic.

28. The method of claim 27, wherein the at least one beneficial characteristic includes at least one of,
a hard link between the token performance and an actual value of the at least one feature of the at least one asset, or
a soft link between the token performance and an expected value of the at least one feature of the at least one asset.

29. The method of claim 1, wherein generating the at least one asset class linked token further comprises:
receiving, via user operations with the tokenization user interface, an intended performance value of the at least one asset class linked token, and
populating the at least one asset class linked token with at least one recommended asset based on the asset class description, wherein the at least one recommended asset is based on the intended performance value of the at least one asset class linked token.

30. The method of claim 29, wherein generating the at least one asset class linked token further comprises:
performing a comparison a projected performance value of the at least one asset class linked token, based on the at least one recommended asset, with the intended performance value of the at least one asset class linked token, and
presenting, via the tokenization user interface, a description of the comparison of the projected performance value with the intended performance value,
wherein the tokenization user interface facilitates an iterative adjustment of the at least one asset class linked token until the projected performance value of the at least one asset class linked token is within a threshold of the intended performance value of the at least one asset class linked token.
